(19) United States
(12) Patent Application Publication
(10) Pub. No.: US 2025/0063281 A1
(43) Pub. Date: Feb. 20, 2025

(54) ACOUSTIC OUTPUT DEVICES

(71) Applicant: SHENZHEN SHOKZ CO., LTD., Shenzhen (CN)

(72) Inventors: Zhen WANG, Shenzhen (CN); Jianing LIANG, Shenzhen (CN); Lei ZHANG, Shenzhen (CN); Xin QI, Shenzhen (CN)

(73) Assignee: SHENZHEN SHOKZ CO., LTD., Shenzhen (CN)

(21) Appl. No.: 18/938,456

(22) Filed: Nov. 6, 2024

Related U.S. Application Data
(63) Continuation of application No. PCT/CN2023/114744, filed on Aug. 24, 2023.

(30) Foreign Application Priority Data
Nov. 21, 2022 (CN) 202211455122.0

(51) Int. Cl. H04R 1/02; H04R 1/24; H04R 7/16

(52) U.S. Cl. CPC H04R 1/025; H04R 1/24; H04R 7/16

(57) ABSTRACT

An acoustic output device comprises a housing, a first loudspeaker and a second loudspeaker disposed in the housing. The first loudspeaker includes a first diaphragm. In the housing, a first front cavity and a first rear cavity are respectively disposed on a front side and a rear side of the first diaphragm, and the first front cavity and the first rear cavity are acoustically coupled with two hole portions disposed on the housing, respectively, to output a first sound wave and a second sound wave. The second loudspeaker includes a second diaphragm. In the housing, a second front cavity and a second rear cavity are respectively disposed on a front side and a rear side of the second diaphragm, and only one of the second front cavity and the second rear cavity is acoustically coupled with a hole portion disposed on the housing to output a third sound wave.

### CROSS-REFERENCE TO RELATED APPLICATIONS

This application is a continuation of International Application No. PCT/CN2023/114744, filed on Aug. 24, 2023, which claims priority to Chinese Patent Application No. 202211455122.0, filed on Nov. 21, 2022, the entire contents of which are incorporated herein by reference.

### TECHNICAL FIELD

The present disclosure relates to the field of acoustics, and in particular to an acoustic output device.

### BACKGROUND

In order to solve the sound leakage problem of the acoustic output device, two sound signals with opposite phases may be emitted using two or more sound sources. Under the far-field condition, an acoustic path difference between the two sound sources with opposite phases and a certain point in the far-field is basically negligible, so the two sound signals can destruct each other out to reduce far-field sound leakage. Although the effect of reducing sound leakage is achieved to a certain extent, certain limitations exist. For example, since the wavelength of high-frequency sound leakage is short, the distance between the two sound sources under the far-field condition cannot be ignored compared to the wavelength, resulting in the inability to destruct the sound signals emitted by the two sound sources. As another example, when the acoustic transmission structure of the acoustic output device resonates, there is a certain phase difference between the phase of the sound signal actually radiated by the sound outlet hole of the acoustic output device and the original phase at a position where the sound wave generates, and an additional resonance peak is added to the transmitted sound wave, resulting in a chaotic sound field distribution. Thus, it is difficult to ensure the effect of sound leakage reduction in the far-field at the high frequency, and may even increase the sound leakage.

Therefore, it is desirable to provide an acoustic output device with a good directional sound field.

### SUMMARY

The embodiments of the present disclosure provide an acoustic output device, comprising: a housing; a first loudspeaker disposed in the housing, wherein the first loudspeaker may include a first diaphragm, and in the housing, a first front cavity and a first rear cavity may be respectively disposed on a front side and a rear side of the first diaphragm, and the first front cavity and the first rear cavity are acoustically coupled with two hole portions disposed on the housing, respectively, to output a first sound wave and a second sound wave having a phase difference; and a second loudspeaker disposed in the housing, wherein the second loudspeaker may include a second diaphragm, and in the housing, a second front cavity and a second rear cavity may be respectively disposed on a front side and a rear side of the second diaphragm, and only one of the second front cavity and the second rear cavity may be acoustically coupled with a hole portion disposed on the housing to output a third sound wave.

In some embodiments, the first loudspeaker may be driven by a first electrical signal, and the second loudspeaker may be driven by a second electrical signal. In a target frequency range, the first electrical signal and the second electrical signal may have a difference in amplitude and/or phase, and the superposition of the first sound wave, the second sound wave, and the third sound wave may generate a directional far-field radiation from the acoustic output device.

In some embodiments, a vibration direction of the first diaphragm and a vibration direction of the second diaphragm may be the same. The first diaphragm and the second diaphragm may be arranged at intervals along the vibration direction or a direction perpendicular to the vibration direction.

In some embodiments, the first front cavity and the first rear cavity may be respectively coupled with a first hole portion and a second hole portion disposed on the housing. One of the second front cavity and the second rear cavity may share the same cavity with the first rear cavity. The second front cavity or the second rear cavity that shares the same cavity with the first rear cavity may output the third sound wave through the second hole portion.

In some embodiments, a resonance frequency of the same cavity may not be less than 4 kHz.

In some embodiments, a volume of the same cavity may not be greater than 0.28 cm³, and an area of the second hole portion may not be less than 20 mm².

In some embodiments, a resonance frequency of the second rear cavity or the second front cavity that is not acoustically coupled with the second hole portion may not be greater than 1 kHz.

In some embodiments, in the target frequency range and under the driving of the same electrical signal, at a far-field position in a specific direction of the acoustic output device, a difference between the superposition of sound pressure levels of the first sound wave and the second sound wave output by the first loudspeaker and a sound pressure level of the third sound wave output by the second loudspeaker may be less than 14 dB.

In some embodiments, the target frequency range may include a range of 1 kHz-4 kHz.

In some embodiments, a direction of an extension line of a connection line between the first hole portion and the second hole portion may be the specific direction.

In some embodiments, the first front cavity and the first rear cavity may be respectively coupled with the first hole portion and the second hole portion disposed on the housing. One of the second front cavity and the second rear cavity may be coupled with a third hole portion disposed on the housing. The third hole portion may be a hole portion different from the first hole portion and the second hole portion.

In some embodiments, the second front cavity or the second rear cavity that is acoustically coupled with the third hole portion may have a resonance frequency. The first rear cavity acoustically coupled with the second hole portion may have a resonance frequency. A difference between the resonance frequency of the second front cavity or the second rear cavity that is acoustically coupled with the third hole portion and the resonance frequency of the first rear cavity acoustically coupled with the second hole portion may not be greater than 3000 Hz.

In some embodiments, the resonance frequency of the second front cavity or the second rear cavity that is acoustically coupled with the third hole portion may not be less than 4 kHz.

In some embodiments, a resonance frequency of the second rear cavity or the second front cavity that is not acoustically coupled with the third hole portion may not be greater than 1 kHz.

In some embodiments, in the target frequency range and under the driving of the same electrical signal, at the far-field position in the specific direction of the acoustic output device, the difference between the superposition of the sound pressure levels of the first sound wave and the second sound wave output by the first loudspeaker and the sound pressure level of the third sound wave output by the second loudspeaker may be less than 14 dB. The target frequency range may include a range of 1 kHz-4 kHz.

In some embodiments, the second hole portion and the third hole portion may form an equivalent hole portion. A direction of an extension line of a connection line between the first hole portion and the equivalent hole portion may be the specific direction.

In some embodiments, in a range of 100 Hz-800 Hz, a difference between a sound pressure level of a sound wave output by the first loudspeaker at a hole portion of the two hole portions that is acoustically coupled with the first rear cavity and a sound pressure level of the third sound wave output by the second loudspeaker at the hole portion acoustically coupled therewith may not be less than 6 dB.

In some embodiments, in a wearing state, a hole portion of the two hole portions that is acoustically coupled with the first front cavity of the first loudspeaker may be arranged closer to an ear of a user. A hole portion of the two hole portions that is acoustically coupled with the first rear cavity and the hole portion of the second loudspeaker outputting the third sound wave may be arranged further away from the ear of the user. The hole portion of the two hole portions that is acoustically coupled with the first rear cavity and the hole portion of the second loudspeaker outputting the third sound wave may form an equivalent hole portion. A direction from the equivalent hole portion to the hole portion of the two hole portions that is acoustically coupled with the first front cavity may point to the ear of the user.

In some embodiments, in the wearing state, the hole portion of the two hole portions that is acoustically coupled with the first front cavity of the first loudspeaker may be arranged closer to the ear of the user. The hole portion of the two hole portions that is acoustically coupled with the first rear cavity may be arranged further away from the ear of the user. A direction from the hole portion of the two hole portions that is acoustically coupled with the first rear cavity to the hole portion of the two hole portions that is acoustically coupled with the first front cavity may point to the ear of the user.

In some embodiments, the acoustic output device may comprise at least one of a rear-mounted earphone, an ear hook earphone, an in-ear earphone, and glasses. In the wearing state, a direction opposite to the specific direction may point to an opening of an ear canal of the user.

In some embodiments, the second front cavity or the second rear cavity that is not acoustically coupled with the hole portion may be filled with acoustic granular material.

### BRIEF DESCRIPTION OF THE DRAWINGS

The present disclosure will be further illustrated by way of exemplary embodiments, which will be described in detail by means of the accompanying drawings. These embodiments are not limiting, and in these embodiments, the same numbering indicates the same structure, where:

FIG. 1 is a schematic diagram illustrating a relative position of an acoustic output device and an ear of a user according to some embodiments of the present disclosure;

FIG. 2A is a schematic diagram illustrating a sound field distribution of a sound pressure level of the acoustic output device in FIG. 1 at medium and low frequencies;

FIG. 2B is a schematic diagram illustrating a sound field distribution of a sound pressure level of the acoustic output device in FIG. 1 at a high frequency;

FIG. 3 is a schematic diagram illustrating a frequency response curve of the acoustic output device in FIG. 1;

FIG. 4 is a schematic diagram illustrating a directionality according to some embodiments of the present disclosure;

FIGS. 5A-5D are schematic structural diagrams illustrating acoustic output devices each of which including a first loudspeaker and a second loudspeaker with different arrangements according to some embodiments of the present disclosure;

FIG. 6 is a schematic diagram illustrating a relationship between a resonance frequency and a volume of the same cavity according to some embodiments of the present disclosure;

FIG. 7 is a schematic diagram illustrating a relationship between a resonance frequency of the same cavity and an area of a hole portion acoustically coupled with the cavity according to some embodiments of the present disclosure;

FIG. 8 is a schematic diagram illustrating a relationship between a resonance frequency of a closed cavity and a volume thereof according to some embodiments of the present disclosure;

FIG. 9 is a schematic structural diagram illustrating an acoustic output device according to some embodiments of the present disclosure;

FIGS. 10A-10D are schematic diagrams illustrating acoustic output devices each of which including a sound outlet hole with different arrangements according to some embodiments of the present disclosure;

FIGS. 11A-11D are schematic diagrams illustrating directionalities of a far-field radiation from the acoustic output devices in FIGS. 10A-10D;

FIGS. 12A-12B are schematic diagrams illustrating directionalities of a far-field radiation from acoustic output devices each of which including a hole portion with an exemplary arrangement position according to some embodiments of the present disclosure;

FIG. 13 is a schematic diagram illustrating another acoustic output device according to some embodiments of the present disclosure;

FIG. 14 is a schematic diagram illustrating an acoustic transmission of an acoustic output device including a second loudspeaker according to some embodiments of the present disclosure;

FIG. 15 is a flowchart illustrating an exemplary process of adjusting a second electrical signal according to some embodiments of the present disclosure;

FIG. 16 is a schematic diagram illustrating frequency response curves when a single sound source and a dual sound source are excited separately according to some embodiments of the present disclosure;

FIG. 17 is a schematic diagram illustrating a directionality of a far-field radiation from an acoustic output device after a second electrical signal is adjusted according to some embodiments of the present disclosure;

FIGS. 18A-18B are schematic diagrams illustrating test curves of directionalities of acoustic output devices according to some embodiments of the present disclosure;

FIG. 19 is a schematic diagram illustrating an equivalent model of an acoustic output device adjusted according to a preset algorithm according to some embodiments of the present disclosure;

FIG. 20 is a schematic diagram illustrating an equivalent model of an acoustic output device adjusted according to an active algorithm according to some embodiments of the present disclosure; and

FIG. 21 is a schematic block illustrating an amplitude and phase adjustment algorithm according to some embodiments of the present disclosure.

### DETAILED DESCRIPTION

In order to more clearly illustrate the technical solutions of the embodiments of the present disclosure, the accompanying drawings required to be used in the description of the embodiments are briefly described below. Obviously, the accompanying drawings in the following description are only some examples or embodiments of the present disclosure, and it is possible for a person of ordinary skill in the art to apply the present disclosure to other similar scenarios in accordance with these drawings without creative labor. Unless obviously obtained from the context or the context illustrates otherwise, the same numeral in the drawings refers to the same structure or operation.

It should be understood that the terms “system,” “device,” “unit,” and/or “module” used herein are a way to distinguish between different components, elements, parts, sections, or assemblies at different levels. However, the terms may be replaced by other expressions if other words accomplish the same purpose.

As shown in the present disclosure and in the claims, unless the context clearly suggests an exception, the words “one,” “a,” “an,” “one kind,” and/or “the” do not refer specifically to the singular, but may also include the plural. Generally, the terms “including,” and “comprising” suggest only the inclusion of clearly identified steps and elements, however, the steps and elements that do not constitute an exclusive list, and the method or apparatus may also include other steps or elements.

Flowcharts are used in the present disclosure to illustrate the operations performed by a system according to embodiments of the present disclosure, and the related descriptions are provided to aid in a better understanding of the magnetic resonance imaging method and/or system. It should be appreciated that the preceding or following operations are not necessarily performed in an exact sequence. Instead, steps can be processed in reverse order or simultaneously. Also, it is possible to add other operations to these processes or to remove a step or steps from these processes.

In some embodiments, in order to solve the sound leakage problem of the acoustic output device, sound signals with opposite phases may be emitted using two sound sources with opposite phases. Under the far-field condition, the difference in a sound path between two the sound sources with opposite phases to a certain point in the far-field is basically negligible, so the two sound signals can destruct each other to reduce far-field sound leakage.

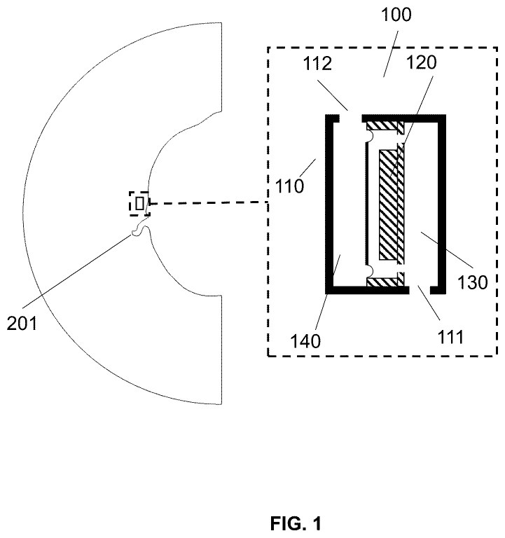

FIG. 1 is a schematic diagram illustrating a relative position of an acoustic output device and an ear of a user according to some embodiments of the present disclosure. As shown in FIG. 1, an acoustic output device 100 may include a housing 110 and a loudspeaker 120. The loudspeaker 120 may be disposed in a cavity formed by the housing 110. The loudspeaker 120 may include a diaphragm (not shown in the figure). In the cavity of the housing 110, a front cavity 130 and a rear cavity 140 configured to radiate a sound may be provided on a front side and a rear side of the diaphragm, respectively. The housing 110 may be provided with a first hole portion 111 and a second hole portion 112. The front cavity 130 may be acoustically coupled with the first hole portion 111, and the rear cavity 140 may be acoustically coupled with the second hole portion 112. When the loudspeaker 120 outputs a sound wave, the sound wave (or referred to as a first sound wave) on the front side of the diaphragm may be emitted from the first hole portion 111 through the front cavity 130, and the sound wave (or referred to as a second sound wave) on the rear side of the diaphragm may be emitted from the second hole portion 112 through the rear cavity 140. In this case, the first hole portion 111 and the second hole portion 112 may be regarded as a set of dual sound sources capable of emitting two sets of sounds with the same amplitude but opposite phases. For ease of understanding, in some embodiments of the present disclosure, the front side of the diaphragm refers to a side of the diaphragm away from a magnetic circuit assembly (not shown in the figure), and the rear side of the diaphragm refers to a side of the diaphragm facing the magnetic circuit assembly. In some embodiments, the front side and the rear side of the diaphragm are interchangeable. For example, the side of the diaphragm away from the magnetic circuit assembly may be regarded as the rear side, and the side of the diaphragm facing the magnetic circuit assembly may be regarded as the front side.

In some embodiments, as shown in FIG. 1, when a user wears or uses the acoustic output device 100, the acoustic output device 100 may be located near an auricle of the user, and the first hole portion 111 may face an opening 201 of an ear canal of the user, such that the sound transmitted from the first hole portion 111 may propagate toward an earhole of the user. The second hole portion 112 may be away from the opening 201 of the ear canal relative to the first hole portion 111. A distance between the first hole portion 111 and the opening of the ear canal may be less than a distance between the second hole portion 112 and the opening of the ear canal.

In some embodiments, when the loudspeaker 120 vibrates, the front and rear sides of the loudspeaker 120 may respectively serve as a sound wave generation structure to generate sound waves with equal amplitude and opposite phases. In some embodiments, the sound waves with equal amplitude and opposite phases may be radiated outward through the first hole portion 111 and the second hole portion 112, respectively, to form the dual sound sources. The dual sound sources may have destructively interference at a spatial point (e.g., a far-field), thereby effectively improving the sound leakage problem in the far-field of the acoustic output device 100.

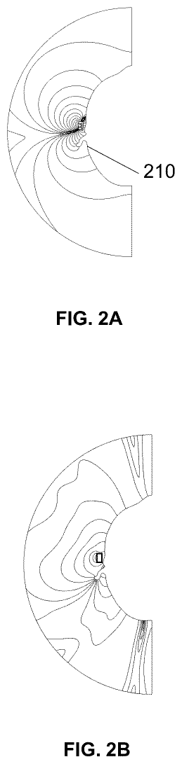

FIG. 2A is a schematic diagram illustrating a sound field distribution of a sound pressure level of the acoustic output device in FIG. 1 at medium and low frequencies. As shown in FIG. 2A, in a range of medium and low frequencies (e.g., 50 Hz-1 kHz), the sound field distribution of the acoustic output device 100 presents a good dual sound source directionality, and the effect of sound leakage reduction is significant. That is to say, in the range of medium and low frequencies, the dual sound sources formed by the first hole portion 111 and the second hole portion 112 of the acoustic output device 100 may output sound waves (i.e., a first sound wave and a second sound wave) with opposite phases, and a distribution mode of two lobe structures may be formed in the sound field in the space. In two opposite directions of a connection line between the dual sound sources, a sound pressure level may be relatively large, while in a direction perpendicular to the connection line between the dual sound sources, a sound pressure level may be relatively small. However, for the two lobe structures formed in the sound field, one of the lobe structures may be away from the ear of the user, which forms relatively large sound leakage, thereby affecting the effect of sound leakage reduction of the acoustic output device.

In some embodiments, in a relatively high frequency range, wavelengths of the first sound wave and the second sound wave may be relatively short, and the distance between the dual sound sources formed by the first hole portion 111 and the second hole portion 112 may not be ignored compared to the wavelength. For example, the distance between the first hole portion 111 and the second hole portion 112 may make a sound path of the first sound wave from a spatial point (e.g., a far-field) and a sound path of the second sound wave from the spatial point (e.g., the far-field) different, such that a phase difference between the first sound wave and the second sound wave at the spatial point may be small (e.g., the phase is the same or similar), the first sound wave and the second sound wave cannot have destructively interference at the spatial point, and may also be superposed at the spatial point to increase an amplitude of the sound wave at the spatial point. In some embodiments, due to the shielding of a high-frequency sound wave by structures such as the auricle 210 and/or the influence of a reflected sound wave, the sound field distribution of the acoustic output device 100 may also be chaotic.

In some embodiments, the front cavity 130 and the rear cavity 140 may have different structures and parameters (e.g., the volume, etc.), which may cause the front cavity 130 and the rear cavity 140 to have different resonance frequencies. In some embodiments, the front cavity 130 and/or the rear cavity 140 may be additionally provided with a special acoustic structure (e.g., a sound guiding tube, etc.) to adjust the resonance frequency. When the sound wave in the front cavity 130 and/or the rear cavity 140 resonates, a frequency component (e.g., an additional resonance peak may be added to the transmitted sound wave) of the sound wave transmitted in the front cavity 130 and/or the rear cavity 140 may be changed, or a phase of the transmitted sound wave may be changed. Compared with the situation of no resonance, the phase and/or amplitude of the sound wave radiated from the first hole portion 111 and/or the second hole portion 112 may be changed, which may cause the chaotic sound field of the dual sound sources in the high frequency range, affecting the effect of destructively interference of the sound waves radiated from the first hole portion 111 and the second hole portion 112 at the spatial point. For example, when resonance occurs, the phase difference of the sound waves radiated from the first hole portion 111 and the second hole portion 112 may change. For example, when the phase difference of the sound waves radiated from the first hole portion 111 and the second hole portion 112 is small (e.g., less than 120°, less than 90° or 0, etc.), the effect of destructively interference of the sound waves at the spatial point may be weakened, which is difficult to achieve the effect of sound leakage reduction; or the sound waves with a small phase difference may also be superposed with each other at the spatial point, thereby increasing the amplitude of the sound waves at the spatial point (e.g., the far-field) near the resonance frequency, and increasing the far-field sound leakage of the acoustic output device 100. As another example, the resonance may increase (e.g., manifested as a resonance peak near the resonance frequency) the amplitude of the transmitted sound waves near the resonance frequency of an acoustic transmission structure, thereby resulting in the chaotic sound field of the dual sound sources near the resonance frequency. In this case, the amplitude of the sound waves radiated from the first hole portion 111 and the second hole portion 112 may be greatly different, and the effect of destructively interference of the sound waves at the spatial point may be weakened, which is difficult to achieve the effect of sound leakage reduction.

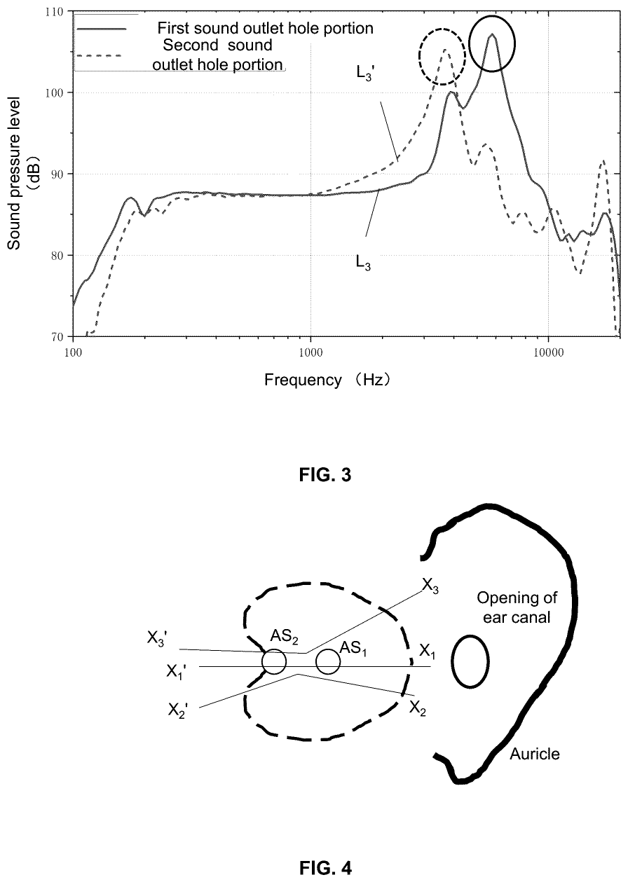

FIG. 2B is a schematic diagram illustrating a sound field distribution of a sound pressure level of the acoustic output device in FIG. 1 at a high frequency. FIG. 3 is a schematic diagram illustrating a frequency response curve of the acoustic output device in FIG. 1. As shown in FIG. 2B, in a relatively high frequency range, an acoustic signal radiated outward from the second hole portion 112 of the acoustic output device 100 may play a dominant role in the entire sound field distribution, and the sound field distribution may be relatively chaotic. There is a certain difference between the amplitude/phase of the sound wave actually radiated from the second hole portion 112 of the acoustic output device 100 and the original amplitude/phase of the sound wave emitted from the loudspeaker 120, resulting in that the two sound waves radiated from the first hole portion 111 and the second hole portion 112 not only fail to reduce the sound leakage at a specific position in the far-field, but also increase the sound leakage at the position.

As shown in FIG. 3, a curve L₃ represents a frequency response curve of the front cavity 130 (e.g., at the first hole portion 111) of the acoustic output device 100, and a curve L₃′ represents a frequency response curve of the rear cavity 140 (e.g., at the second hole portion 112) of the acoustic output device 100. As can be seen from FIG. 3, in the high frequency range, the front cavity 130 (having a resonance peak at a frequency of about 6 kHz) and the rear cavity 140 (having a resonance peak at a frequency of about 4 kHz) of the acoustic output device 100 have significantly different resonance peaks. By comparing the curve L₃ and the curve L₃′, it can be seen that sound outputs of the front and rear cavities of the acoustic output device 100 in the medium and low frequency range (e.g., 50 Hz-1 500 Hz) are roughly equal, showing a good effect of sound leakage reduction. However, in the high frequency range (e.g., 1500 Hz-20 kHz), the sound outputs of the front and rear cavities are different greatly, and the effect of sound leakage reduction is significantly weakened. Referring to FIG. 2B and FIG. 3, it can be seen that in the high frequency range, the sound field distribution of the dual sound sources is relatively chaotic, which may not reduce the sound leakage in the far-field, and may even increase the sound leakage in the far-field. In some embodiments, the sound field distribution of the dual sound sources may be adjusted by adjusting the structure of the acoustic output device 100 to obtain a good directional sound field, thereby improving the problem of increased sound leakage in the far-field of the acoustic output device 100.

In some embodiments, a second loudspeaker may be provided in the acoustic output device such that a sound wave of the second loudspeaker and the sound wave generated by the loudspeaker 120 (or referred to as the first loudspeaker) may destruct each other, thereby suppressing the chaotic sound field of the structure of the dual sound sources (e.g., in the high frequency range), and reducing or eliminating the sound leakage of the acoustic output device in the far-field. In some embodiments, the acoustic output device may include a housing, a first loudspeaker, and a second loudspeaker. The first loudspeaker may be disposed in the housing. The first loudspeaker may be acoustically coupled with two hole portions (e.g., a first hole portion and a second hole portion) disposed on the housing to respectively output a first sound wave and a second sound wave with a phase difference. In some embodiments, the first loudspeaker may include a first diaphragm. In the housing, a front side and a rear side of the first diaphragm may be provided with a first front cavity and a first rear cavity, respectively. The first front cavity and the first rear cavity may be acoustically coupled with the two hole portions (e.g., the first hole portion and the second hole portion) to output the first sound wave and the second sound wave with a phase difference, respectively. In some embodiments, the first loudspeaker may be driven by a first electrical signal to output the first sound wave and the second sound wave with the phase difference through the two hole portions (e.g., the first hole portion and the second hole portion). The second loudspeaker may be disposed in the housing, and the second loudspeaker may be acoustically coupled with a hole portion (e.g., a third hole portion. The third hole portion may be one of the first hole portion and the second hole portion, or may be another hole portion different from the first hole portion and the second hole portion) disposed on the housing. In some embodiments, the second loudspeaker may include a second diaphragm. In the housing, a second front cavity and a second rear cavity may be disposed on a front side and a rear side of the second diaphragm, respectively. Only one of the second front cavity and the second rear cavity may be acoustically coupled with the one hole portion (e.g., the third hole portion) to output a third sound wave. In some embodiments, the second loudspeaker may be driven by a second electrical signal to output the third sound wave through one hole portion (e.g., the third hole portion). In this case, the first sound wave and the second sound wave of the first loudspeaker may be respectively output through the two hole portions (e.g., the first hole portion and the second hole portion) to form dual sound sources. The second loudspeaker only outputs the third sound wave through one hole portion (e.g., the third hole portion) to form a single sound source. In some embodiments, in a target frequency range, the third sound wave output by the second loudspeaker and the first sound wave and the second sound wave output by the first loudspeaker may be destructively superposed at a far-field position in a specific direction of the acoustic output device, a sound pressure after destructive superposition at the position may be relatively small (e.g., close to zero), and a sound pressure at a corresponding far-field position in an opposite direction of the specific direction may be large, such that an absolute value of a difference between sound pressure levels at the two positions may not be less than a preset sound pressure level threshold, and a far-field radiation from the acoustic output device may be directional. A distance between the far-field position in the specific direction and the acoustic output device and a distance between the corresponding far-field position in the opposite direction and the acoustic output device may be equal. In some embodiments, the sound pressure levels at the two far-field positions in the specific direction and the corresponding opposite direction may be measured by test microphones disposed at the two far-field positions to obtain the sound pressures at the corresponding far-field positions, then the corresponding sound pressure levels may be obtained based on the sound pressures, and finally the difference between the sound pressure levels of the two far-field positions in the specific direction and the opposite direction may be obtained.

In order to ensure that the sound wave (e.g., the sound wave after the superposition of the first sound wave and the second sound wave) output by the first loudspeaker and the sound wave output by the second loudspeaker (e.g., the third sound wave) can effectively destruct each other at the far-field position, the sound wave output by the first loudspeaker and the sound wave output by the second loudspeaker should have equal or similar amplitudes and opposite or approximately opposite phases at the far-field position. Considering that frequency responses of the first loudspeaker and the second loudspeaker at the far-field position may be different due to the different structures under the driving of the same electrical signal, electrical signals of different intensities may be provided to the first loudspeaker and the second loudspeaker to compensate the difference in the frequency responses, such that the sound wave output by the first loudspeaker and the sound wave output by the second loudspeaker finally have the same or similar amplitudes at the far-field position. For example, a processing circuit may provide different degrees of gain for the two electrical signals driving the first loudspeaker and the second loudspeaker to compensate the difference in the frequency responses. In order to reduce the difficulty of adjusting the electrical signal and improve the stability of the electrical signal, the difference in the frequency responses of the first loudspeaker and the second loudspeaker at the far-field position may be reduced. For example, the difference in the frequency responses of the first loudspeaker and the second loudspeaker at the far-field position may be reduced by adjusting the structures of the first loudspeaker and the second loudspeaker, such as the volume of the cavity, the size and the position of the hole portion, etc. More descriptions regarding adjusting the parameters related to the structures of the first loudspeaker and the second loudspeaker may be found elsewhere the present disclosure. The difference in the frequency responses of the first loudspeaker and the second loudspeaker at the far-field position is reduced described here can be understood as in the target frequency range, under the driving of the same electrical signal (i.e., the first electrical signal is the same as the second electrical signal), at the far-field position in the specific direction of the acoustic output device, the difference between the sound pressure levels of the sound wave after the superposition of the first sound wave and the second sound wave output by the first loudspeaker and the third sound wave output by the second loudspeaker may be less than 14 dB, such that after the first electrical signal or the second electrical signal undergoes appropriate amplitude-frequency adjustment. The first sound wave and the second sound wave output by the first loudspeaker and the third sound wave output by the second loudspeaker may be destructively superposed at the far-field position in the specific direction of the acoustic output device, and the sound pressure at the far-field position may be low (e.g., close to zero). In some embodiments, in order to reduce the sound pressure at the far-field position in the specific direction of the acoustic output device and improve the effect of sound leakage reduction of the acoustic output device, in the target frequency range, under the same electrical signal (e.g., the first electrical signal is the same as the second electrical signal), at the far-field position in the specific direction of the acoustic output device, the difference between the sound pressure levels of the sound wave after the superposition of the first sound wave and the second sound wave output by the first loudspeaker and the third sound wave output by the second loudspeaker may be less than 10 dB. In some embodiments, in order to further reduce the sound pressure at the far-field position in the specific direction of the acoustic output device and improve the effect of sound leakage reduction of the acoustic output device, in the target frequency range, under the driving of the same electrical signal (e.g., the first electrical signal is the same as the second electrical signal), at the far-field position in the specific direction of the acoustic output device, the difference between the sound pressure levels of the sound wave after the superposition of the first sound wave and the second sound wave output by the first loudspeaker and the third sound wave output by the second loudspeaker may be less than 6 dB. In some embodiments, the target frequency range may include a first frequency range. In the first frequency range, the superposition of the first sound wave, the second sound wave, and the third sound wave may generate a cardioid directional far-field radiation from the acoustic output device. In some embodiments, the target frequency range may include a second frequency range. In the second frequency range, the sound pressure level of the third sound wave may be much less than that of the second sound wave. When the first sound wave, the second sound wave, and the third sound wave are superposed with each other, the influence of the third sound wave may be ignored. The first sound wave and the second sound wave may be regarded as the dual sound sources superposed with each other, such that the far-field radiation from the acoustic output device may have a dual sound source directionality. In some embodiments, the first frequency range may include a medium and high frequency band (e.g., 800 Hz-10 kHz, etc.), and the second frequency range may include a medium and low frequency band (e.g., 100 Hz-800 Hz, etc.). More descriptions regarding the directionality and the cardioid directionality of the acoustic output device may be found in FIG. 4 and related descriptions thereof. More descriptions regarding the dual sound source directionality may be found in FIG. 2A and related descriptions thereof.

In some embodiments, the acoustic output device may include at least one of a rear-mounted earphone, an ear-mounted earphone, an in-ear earphone, and glasses. In a wearing state, the opposite direction of the specific direction may point to an opening of an ear canal of a user. FIG. 4 is a schematic diagram illustrating a directionality according to some embodiments of the present disclosure. Referring to FIG. 4, the acoustic output device shown in FIG. 4 is in the wearing state, AS₁ represents a sound outlet hole portion of a front cavity of the acoustic output device, and AS₂ represents a sound outlet hole portion of a rear cavity of the acoustic output device. In some embodiments, the directionality of the far-field radiation is manifested as follows: a direction of an output sound of the acoustic output device may be within a specified direction range, i.e., the far-field radiation from the acoustic output device within the specified direction range may be significantly greater than the far-field radiation outside the specified direction range. In some embodiments, when the acoustic output device is in the wearing state, a direction X₁ (i.e., the direction X₁ from the sound output hole portion AS₂ of the rear cavity to the sound output hole portion AS₁ of the front cavity) from a hole portion AS₂ for sound output corresponding to the rear cavity of the acoustic output device to a hole portion AS₁ for sound output corresponding to the front cavity and directions near the direction X₁ (e.g., a direction X₂, and direction X₃) may point to the operation of the ear canal of the user. That is, in the wearing state, the sound output hole portion AS₁ corresponding to the front cavity of the acoustic output device may be closer to the opening of the ear canal of the user. A direction X₁′ from the sound output hole portion AS₁ of the front cavity to the sound output hole portion AS₂ of the rear cavity and directions near the direction X₁′ (e.g., a direction X₂′, and direction X₃′) may be directions of the acoustic output device away from the opening of the ear canal of the user. In some embodiments, in the wearing state and/or a non-wearing state, the direction X₁ from the sound output hole portion AS₂ of the rear cavity of the acoustic output device to the sound output hole portion AS₁ of the front cavity and the directions near the direction X₁ may constitute the specified direction range. The far-field radiation from the acoustic output device in the direction X₁ and the directions near the direction X₁ may be significantly greater than the far-field radiation in other direction ranges (e.g., a direction range perpendicular to the direction X₁ and the directions near the direction X₁, a direction range opposite to the direction X₁ and the directions near the direction X₁, etc.). In some embodiments, the directionality of the acoustic output device is manifested as follows: an absolute value of a difference between the sound pressure levels at two corresponding far-field positions in the specific direction of the acoustic output device and in the opposite direction of the specific direction may not be less than a preset sound pressure level threshold. In the wearing state, the specific direction refers to a direction of the acoustic output device away from the opening of the ear canal of the user, and the opposite direction of the specific direction refers to a direction of the acoustic output device pointing to the opening of the ear canal of the user. In some embodiments, the specific direction refers to the direction X₁′ from the sound outlet hole portion AS₁ of the front cavity to the sound outlet hole portion AS₂ of the rear cavity and the directions near the direction X₁′; the opposite direction of the specific direction refers to the direction X₁ from the sound outlet hole portion AS₂ of the rear cavity to the sound outlet hole portion AS₁ of the front cavity and the directions near the direction X₁. In some embodiments, the directions near the direction X₁′ may be regarded as directions with angles of less than 60° with the direction X₁′. It should be noted that for the ease of understanding of the directionality, only two hole portions, AS₁ and AS₂, are used for exemplary illustration here. When there are more different hole portions in the acoustic output device, AS₁ may be regarded as an equivalent hole portion formed by some of the hole portions, and AS₂ may be regarded as an equivalent hole portion formed by other hole portions. In this case, the direction of the directionality may be determined by a position of the equivalent hole portion. In some embodiments, the position of the equivalent hole portion formed by a plurality of hole portions may be determined by connecting center points of adjacent hole portions in sequence to form a polygon or a polyhedron. A centroid of the polygon or the polyhedron may be a center point of the equivalent hole portion, and may be configured to indicate the position of the equivalent hole portion.

In some embodiments, the cardioid directionality of the far-field radiation from the acoustic output device is manifested as: in the specified direction range, an absolute value of a difference between sound pressure levels of a far-field radiation sound from the acoustic output device in at least one pair of opposite directions may not be less than a preset sound pressure level threshold. The at least one pair of opposite directions may be within the specified direction range and the opposite direction range respectively. In some embodiments, the at least one pair of opposite directions may include the specific direction and the opposite direction of the specific direction. That is, the specific direction and the opposite direction of the specific direction may be included in the specified direction range and the opposite direction range, respectively. In some embodiments, the at least one pair of opposite directions may include a pair of opposite directions corresponding to a connection line between the sound outlet hole portion AS₁ (e.g., the first hole portion) of the front cavity and the sound outlet hole portion AS₂ (e.g., the second hole portion) of the rear cavity. The cardioid directionality of the acoustic output device is manifested as that sound field intensities of a pair of opposite or nearly opposite directions in the specified direction range and the opposite direction range have a large difference. For example, the pair of opposite or nearly opposite directions refer to that one direction is located near the direction X₁′ from the sound outlet hole portion of the front cavity to the sound outlet hole portion of the rear cavity, and the other direction is located near the direction X₁ from the sound outlet hole portion of the rear cavity to the sound outlet hole portion of the front cavity. For example, the direction X₁′ may be opposite or nearly opposite to the direction X₁, the direction X₂, and the direction X₃.

With the setting of the cardioid directionality of the far-field radiation from the acoustic output device, the sound output by the acoustic output device can be transmitted more concentratedly in the direction of the opening of the ear canal of the user, reducing the transmission of sound in other directions, improving the sound leakage problem of the acoustic output device, and enhancing the listening effect for the user.

In some embodiments, the preset sound pressure level threshold may be 6 dB. For example, the directionality of the far-field radiation from the acoustic output device is manifested as follows: the absolute value of the difference between the sound pressure levels of the far-field radiation sounds from the acoustic output device in the at least one pair of opposite directions (e.g., direction X₁ and direction X₁′) may not be less than 6 dB, such that a relatively large volume can be received at the opening of the ear canal of the user, and the user can receive a clear listening effect.

In some embodiments, the first electrical signal driving the first loudspeaker and the second electrical signal driving the second loudspeaker may have an amplitude and/or phase difference in the target frequency range. In the target frequency range, the first sound wave, the second sound wave, and the third sound wave may be destructively superposed with each other at the far-field position in the specific direction of the acoustic output device, such that the sound pressure after destructive superposition may be relatively small (e.g., close to zero), and the far-field radiation from the acoustic output device may be directional, improving the sound leakage problem in the far field of the acoustic output device. In some embodiments, the first electrical signal may be measured by a measuring instrument (e.g., an oscilloscope, etc.) disposed between the first loudspeaker and a corresponding signal generator; the second acoustic signal may be measured by a measuring instrument (e.g., the oscilloscope) disposed between the second loudspeaker and a corresponding signal generator. In some embodiments, an adjusted first electrical signal and/or second electrical signal may be measured by a measuring instrument disposed between the corresponding loudspeaker and a corresponding signal modulator.

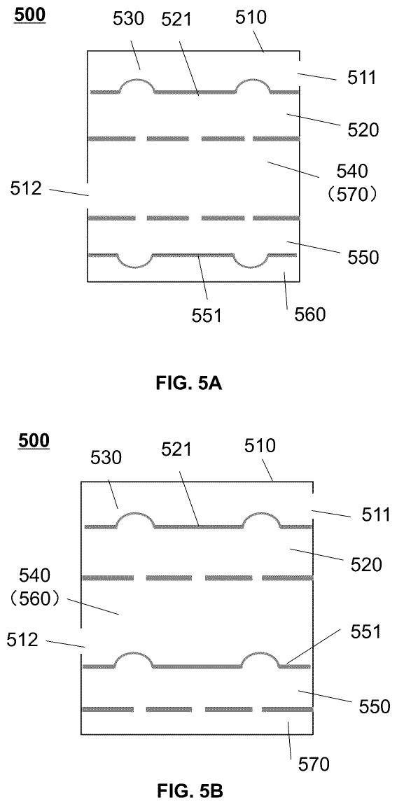

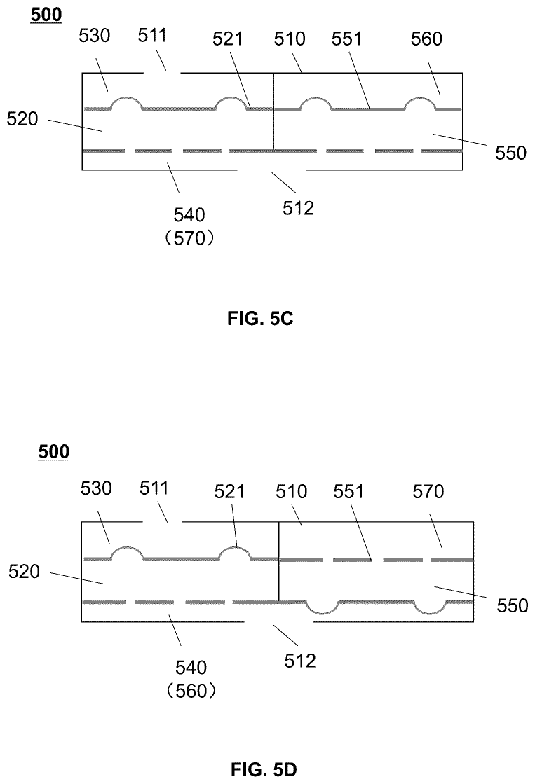

In order to achieve the directionality of the far-field radiation from the acoustic output device, the first loudspeaker and the second loudspeaker may have various arrangements. FIGS. 5A-5D are schematic structural diagrams illustrating acoustic output devices each of which including a first loudspeaker and a second loudspeaker with different arrangements according to some embodiments of the present disclosure. As shown in FIGS. 5A-5D, in some embodiments, a vibration direction of a first diaphragm 521 and a vibration direction of a second diaphragm 551 may be the same (e.g., a vertical direction in FIGS. 5A-5D, etc.). The first diaphragm 521 and the second diaphragm 551 may be arranged at intervals along the vibration direction. For example, a first loudspeaker 520 and a second loudspeaker 550 may be arranged at intervals along the vibration direction (as shown in FIGS. 5A-5B). In some embodiments, the first diaphragm 521 and the second diaphragm 551 may be arranged at intervals in a direction perpendicular to the vibration direction. For example, the first loudspeaker 520 and the second loudspeaker 550 may be arranged at intervals in the direction perpendicular to the vibration direction (as shown in FIGS. 5C-5D). It should be noted that it is an ideal situation that the vibration direction of the first diaphragm 521 and the vibration direction of the second diaphragm 551 are the same. For an actual product, due to factors such as structural design and mounting errors, the vibration direction of the first diaphragm 521 and the vibration direction of the second diaphragm 551 may not be completely the same, but slightly different (e.g., an angle between the vibration directions of the first diaphragm 521 and the vibration direction of the second diaphragm 551 may be less than 10°, etc.). In this case, an arrangement direction of the first loudspeaker 520 and the second loudspeaker 550 or a direction perpendicular to the arrangement direction of the first loudspeaker 520 and the second loudspeaker 550 may be the vibration direction of the first diaphragm 521 or the vibration direction of the second diaphragm 551 or a direction within the angle formed between the vibration direction of the first diaphragm 521 and the vibration direction of the second diaphragm 551. In some embodiments, an orientation of the first diaphragm 521 in the first loudspeaker 520 may be the same as or opposite to an orientation of the second diaphragm 551 in the second loudspeaker 550. In some embodiments, a first rear cavity 540 of the first loudspeaker 520 may be adjacent to or communicate with a second rear cavity 570 of the second loudspeaker 550. In this case, a second front cavity 560 of the second loudspeaker 550 may be closed, as shown in FIG. 5A and FIG. 5C. In some embodiments, the first rear cavity 540 of the first loudspeaker 520 may be adjacent to or communicated with the second front cavity 560 of the second loudspeaker 550. In this case, the second rear cavity 570 of the second loudspeaker 550 may be closed, as shown in FIG. 5B and FIG. 5D. In some embodiments, when volumes of the cavities (e.g., the first front cavity 530, the first rear cavity 540, the second front cavity 560, the second rear cavity 570, etc.) are the same, an acoustic output device 500 shown in FIG. 5A may be equivalent to the acoustic output device 500 shown in FIG. 5C, and the acoustic output device 500 shown in FIG. 5B may be equivalent to the acoustic output device 500 shown in FIG. 5D.

The acoustic output device is exemplarily described below by taking the first loudspeaker and the second loudspeaker being arranged at intervals along the vibration direction as an example.

As shown in FIG. 5A and FIG. 5B, in some embodiments, the acoustic output device 500 may include a housing 510, the first loudspeaker 520, and the second loudspeaker 550. The first loudspeaker 520 may be disposed in the housing 510. The first loudspeaker 520 may include the first diaphragm 521. The first front cavity 530 and the first rear cavity 540 may be disposed on a front side and a rear side of the first diaphragm 521, respectively. The first front cavity 530 and the first rear cavity 540 may be acoustically coupled with a first hole portion 511 and a second hole portion 512 disposed on the housing 510, respectively. The first loudspeaker 520 may be driven by a first electrical signal to output a first sound wave and a second sound wave with a phase difference through the first hole portion 511 and the second hole portion 512. The second loudspeaker 550 may be disposed in the housing 510. The second loudspeaker 550 may include the second diaphragm 551. The second front cavity 560 and the second rear cavity 570 may be disposed on a front side and a rear side of the second diaphragm 551, respectively. One of the second front cavity 560 and the second rear cavity 570 may be the same as the first rear cavity 540. For example, the second front cavity 560 or the second rear cavity 570 constituting the same cavity may be acoustically coupled with the second hole portion 512 on the housing 510. The second loudspeaker 550 may be driven by a second electrical signal to output a third sound wave through the second hole portion 512. In some embodiments, the second front cavity 560 and the first rear cavity 540 may constitute the same cavity. In this case, an orientation of the first diaphragm 521 and an orientation of the second diaphragm 551 may be the same, as shown in FIG. 5B. In some embodiments, the second rear cavity 570 and the first rear cavity 540 may constitute the same cavity. In this case, the orientation of the first diaphragm 521 and the orientation of the second diaphragm 551 may be opposite, as shown in FIG. 5A. Comparing the acoustic output device 500 shown in FIG. 5A with the acoustic output device 500 shown in FIG. 5B, the orientation of the first diaphragm 521 and the orientation of the second diaphragm 551 may be arranged in different directions, so there is a certain difference in frequency response curves of the acoustic output device 500 shown in FIG. 5A and the acoustic output device 500 shown in FIG. 5B, but far-field radiation sounds from the acoustic output device 500 shown in FIG. 5A and the acoustic output device 500 shown in FIG. 5B may achieve directionality. The acoustic output device 500 is described below by taking the following example in which the first loudspeaker 520 and the second loudspeaker 550 shown in FIG. 5A are arranged at intervals and the first diaphragm 521 and the second diaphragm 551 are arranged in opposite directions (e.g., the second rear cavity 570 and the first rear cavity 540 constitute the same cavity).

Correspondingly, referring to FIG. 4, FIG. 5A, and FIG. 5B, the first front cavity 530 may be used as the front cavity of the acoustic output device 500, and the same cavity may be used as the rear cavity of the acoustic output device 500. In this case, the first hole portion 511 may be used as the sound output hole portion AS₁ of the front cavity of the acoustic output device 500, and the second hole portion 512 may be used as the sound output hole portion AS₂ of the rear cavity of the acoustic output device 500. In this case, a direction of an extension line of a connection line between the first hole portion 511 and the second hole portion 512 may be the specific direction.

In some embodiments, by setting the first electrical signal and the second electrical signal to have the amplitude and/or phase difference in the target frequency range, the first sound wave generated by the first loudspeaker 520 in the first front cavity 530, the second sound wave generated by the first loudspeaker 520 in the first rear cavity 540, and the third sound wave generated by the second loudspeaker 550 in the second rear cavity 570 may satisfy a certain phase and amplitude condition at the far-field position in the specific direction of the acoustic output device 500. For example, the superposed sound wave formed by the first sound wave and the second sound wave at the far-field position in the specific direction may have a phase difference with the third sound wave, and after destructive superposition, a sound pressure at the far-field position may be relatively small (e.g., close to zero), such that an absolute value of a difference between sound pressure levels at the far-field position in the specific direction and a corresponding far-field position in an opposite direction of the specific direction may not be less than the preset sound pressure level threshold, thereby realizing the directionality of the acoustic output device 500. Meanwhile, the setting may suppress the chaotic sound field of the dual sound sources in a high frequency range, thereby reducing or eliminating the sound wave radiation from the acoustic output device 500 in the far field.

In order to avoid the resonance frequency of each cavity from interfering with the cardioid directionality of the acoustic output device and improve the listening effect for the user, the resonance frequency of each cavity may fall outside the frequency range for realizing the cardioid directionality by adjusting structural parameters of each cavity. In some embodiments, a target frequency range for the acoustic output device to realize the cardioid directionality may be in a range of a relatively stable frequency response of the first loudspeaker 520 and the second loudspeaker 550. That is, the resonance frequency of the same cavity (e.g., the same cavity formed by the first rear cavity 540 and the second rear cavity 570 in FIG. 5A, and the same cavity formed by the first rear cavity 540 and the second front cavity 560 in FIG. 5B) between the first loudspeaker 520 and the second loudspeaker 550 may determine an upper limit of a frequency at which the cardioid directionality is realized relatively easily. In some embodiments, in order to improve the sound listening effect for the user, the acoustic output device may have the cardioid directionality in a frequency range to which the human ear is sensitive, such as near 3 kHz or near 3.5 kHz. In this case, the upper limit of the frequency range of the far-field radiation from the acoustic output device for realizing the cardioid directionality may not be less than 4 kHz (e.g., the frequency range for realizing the cardioid directionality may be in a range of 1 kHz-4 kHz). In this case, the resonance frequency of the same cavity may not be less than 4 kHz. In some embodiments, due to different application scenarios of the acoustic output device, the frequency range for realizing the cardioid directionality may also be different accordingly. For example, for an acoustic output device that mainly operates under a medium and low frequency condition, the frequency range for realizing the cardioid directionality may be in a range of 800 Hz-2 kHz. In this case, the resonance frequency of the same cavity may not be less than 2 kHz. For an acoustic output device that mainly operates under a medium and high frequency condition, the upper limit of the frequency range for realizing the cardioid directionality may be relatively large, and the corresponding resonance frequency of the same cavity may be relatively large. In order to improve the output quality of the acoustic output device in a sensitive frequency range of the human ear, the resonance frequency of the same cavity may be outside the sensitive frequency range of the human ear, such as greater than 4 kHz, greater than 4.5 kHz, greater than 5 kHz, etc. In this case, the upper limit of the frequency range for realizing the cardioid directionality may be 4 kHz, 4.5 kHz, 5 kHz, etc.

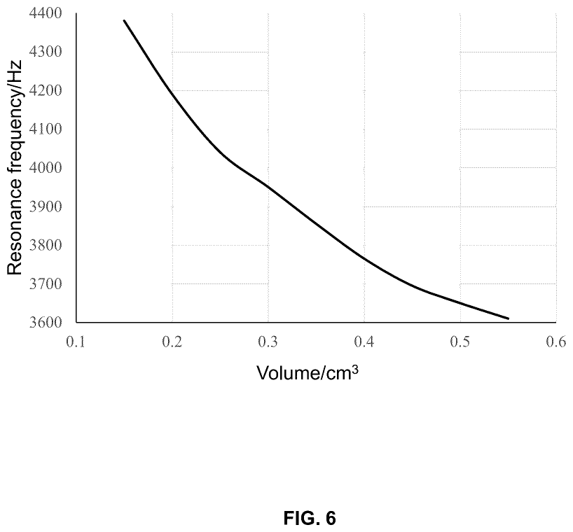

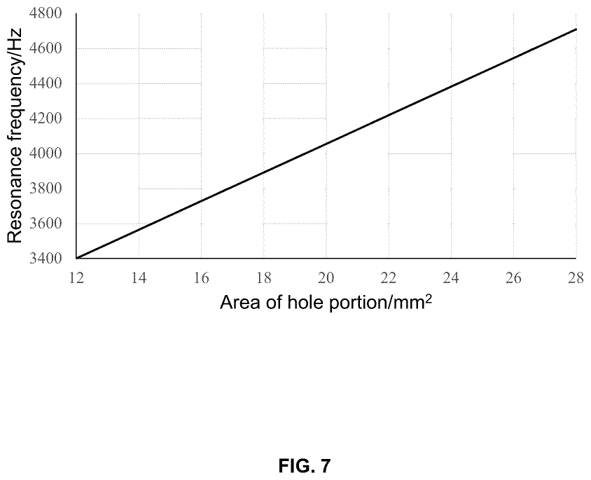

FIG. 6 is a schematic diagram illustrating a relationship between a resonance frequency and a volume of the same cavity according to some embodiments of the present disclosure. FIG. 7 is a schematic diagram illustrating a relationship between a resonance frequency of the same cavity and an area of a hole portion acoustically coupled with the cavity according to some embodiments of the present disclosure. As shown in FIG. 6 and FIG. 7, in some embodiments, when the resonance frequency of the same cavity is adjusted to be not less than 3.8 kHz, the volume of the corresponding same cavity may not be greater than 0.38 cm³, and the area of the second hole portion 512 acoustically coupled with the same cavity may not be less than 17 mm². In some embodiments, when the resonance frequency of the same cavity is adjusted to be not less than 4 kHz, the volume of the corresponding same cavity may not be greater than 0.28 cm³, and the area of the second hole portion 512 acoustically coupled with the same cavity may not be less than 20 mm². In some embodiments, when the resonance frequency of the same cavity is adjusted to be not less than 4.2 kHz, the volume of the corresponding same cavity may not be greater than 0.2 cm³, and the area of the second hole portion 512 acoustically coupled with the same cavity may not be less than 22 mm². In some embodiments, when the resonance frequency of the same cavity is adjusted to be not less than 4.3 kHz, the volume of the corresponding same cavity may not be greater than 0.18 cm³, and the area of the second hole portion 512 acoustically coupled with the same cavity may not be less than 23 mm². By adjusting the volume of the same cavity and the area of the hole portion acoustically coupled with the same cavity, the resonance frequency of the same cavity may be further adjusted to fall outside the frequency range of the acoustic output device for realizing the cardioid directionality, thereby avoiding the interference with the acoustic output device for realizing the cardioid directionality, and improving the listening effect for the user.

In some embodiments, one of the second front cavity 560 and the second rear cavity 570 of the second loudspeaker 550 that does not constitute the same cavity may be a closed cavity, which may not be acoustically coupled with the second hole portion 512. For example, the second front cavity 560 in FIG. 5A is a closed cavity, which is not acoustically coupled with the second hole portion 512. As another example, the second rear cavity 570 in FIG. 5B is a closed cavity, which is not acoustically coupled with the second hole portion 512. In some embodiments, a resonance frequency of the closed cavity may be adjusted not to be greater than a lower frequency limit of the target frequency range for realizing the cardioid directionality, such that the resonance frequency of the closed cavity may not fall within the frequency range of the acoustic output device for realizing the cardioid directionality. In some embodiments, the resonance frequency of the closed cavity may not be greater than 1 kHz, such that the lower frequency limit of the acoustic output device for realizing the cardioid directionality may not be less than 1 kHz (e.g., the frequency range for realizing the cardioid directionality may include a range of 1 kHz-4 kHz), thereby improving the output performance of the acoustic output device in the sensitive frequency range of the human ear. In some embodiments, the resonance frequency of the closed cavity may be less than the lower frequency limit of the frequency range of the acoustic output device for realizing cardioid directionality. For example, the resonance frequency of the closed cavity may not be greater than 800 Hz. In some embodiments, considering factors such as structural design and difficulty in processing and mounting, the resonance frequency of the closed cavity may not be greater than 600 Hz.

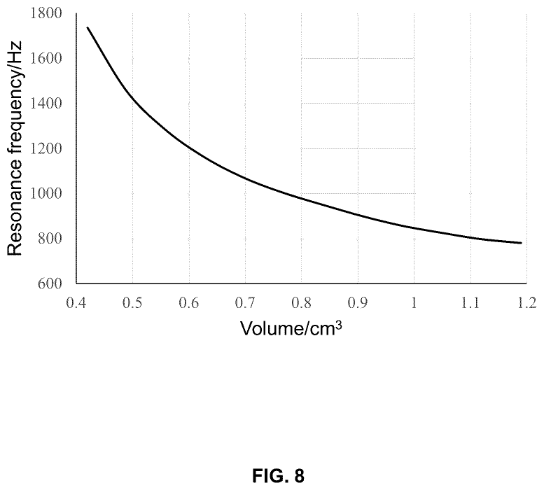

FIG. 8 is a schematic diagram illustrating a relationship between a resonance frequency of a closed cavity and a volume thereof according to some embodiments of the present disclosure. As shown in FIG. 8, in some embodiments, when the resonance frequency of the closed cavity of the second loudspeaker 550 is not greater than 1 kHz, the volume of the corresponding closed cavity may not be less than 0.8 cm³. In some embodiments, when the resonance frequency of the closed cavity of the second loudspeaker 550 is not greater than 1.2 kHz, the volume of the corresponding closed cavity may not be less than 0.6 cm³. In some embodiments, when the resonance frequency of the closed cavity of the second loudspeaker 550 is not greater than 1.4 kHz, the volume of the corresponding closed cavity may not be less than 0.5 cm³. In some embodiments, when the resonance frequency of the closed cavity of the second loudspeaker 550 is not greater than 1.6 kHz, the volume of the corresponding closed cavity may not be less than 0.45 cm³. In some embodiments, when the resonance frequency of the closed cavity of the second loudspeaker 550 is not greater than 0.8 kHz, the volume of the corresponding closed cavity may not be less than 1.1 cm³. By adjusting the volume of the closed cavity, the resonance frequency of the closed cavity may be further adjusted not to be greater than the lower frequency limit of the target frequency range of the acoustic output device for realizing the cardioid directionality, thereby avoiding interference, and improving the listening quality of the user and the effect of sound leakage reduction of the acoustic output device.

In some embodiments, due to the setting of the closed cavity of the second loudspeaker, it is not easy for the second loudspeaker to output a low-frequency sound wave at the acoustically coupled hole portion (e.g., the second hole portion 512). Accordingly, in a low frequency range, a sound pressure of the sound wave output by the second loudspeaker may be much less than a sound pressure of the sound wave output by the first loudspeaker. In this case, the sound wave output by the second loudspeaker may be ignored, the first loudspeaker may mainly output the sound wave for the acoustic output device, and the acoustic output device may achieve a dual sound source directionality. In a medium and high frequency range, the first loudspeaker and the second loudspeaker may cooperate to output sound waves for the acoustic output device, and the acoustic output device may realize the cardioid directionality. In some embodiments, the acoustic output device may realize the dual sound source directionality in a frequency range of 100 Hz-800 Hz, and realize the cardioid directionality in a frequency range of 1 kHz-4 kHz. In some embodiments, the frequency range of the acoustic output device for realizing the dual sound source directionality may be set and adjusted according to an actual condition. For example, the target frequency range of the acoustic output device for realizing the dual sound source directionality may include a range of 100 Hz-1.2 kHz, 100 Hz-1.5 kHz, 200 Hz-2 kHz, etc. In some embodiments, in order to achieve the dual sound source directionality in the target frequency range, the amplitude of the second electrical signal driving the second loudspeaker may be reduced in the target frequency range. For example, the amplitude of the second electrical signal may be adjusted to 0 in the target frequency range, i.e., the second electrical signal is not provided in the target frequency range. In some embodiments, the lower frequency limit of the frequency range of the acoustic output device for realizing the cardioid directionality may be greater than the upper frequency limit of the frequency range for realizing the dual sound source directionality, so as to avoid the chaotic sound field of the acoustic output device. When the target frequency range of the acoustic output device for realizing the dual sound source directionality is different, the medium and high frequency range of the acoustic output device for realizing the cardioid directionality may also change accordingly. Since the resonance frequency of the closed cavity of the second loudspeaker affects the lower frequency limit of the frequency range for realizing the cardioid directionality, the resonance frequency of the closed cavity of the second loudspeaker may change accordingly. For example, when the acoustic output device realizes the dual sound source directionality in a range of 100 Hz-800 Hz and realizes the cardioid directionality in a range of 1 kHz-4 kHz, the resonance frequency of the closed cavity of the second loudspeaker may not be greater than 1 kHz. As another example, when the acoustic output device realizes the dual sound source directionality in a range of 100 Hz-1.2 kHz and realizes the cardioid directionality in a range of 1.5 kHz-4 kHz, the resonance frequency of the closed cavity of the second loudspeaker may not be greater than 1.5 kHz. In some embodiments, in the wearing state, the hole portion of the first loudspeaker acoustically coupled with the first front cavity may be disposed close to the ear of the user, while the hole portion acoustically coupled with the first rear cavity may be disposed away from the ear of the user. A direction from the hole portion acoustically coupled with the first rear cavity to the hole portion acoustically coupled with the first front cavity may point to the ear of the user, i.e., the dual sound source directionality formed in the low frequency range may point to the ear of the user. In some embodiments, in the wearing state, the hole portion of the first loudspeaker acoustically coupled with the first front cavity may be disposed close to the ear of the user, and the hole portion acoustically coupled with the first rear cavity and the hole portion through which the second loudspeaker outputs the third sound wave may be disposed away from the ear of the user. The hole portion acoustically coupled with the first rear cavity and the hole portion through which the second loudspeaker outputs the third sound wave may have an equivalent hole portion. A direction from the equivalent hole portion to the hole portion acoustically coupled with the first front cavity may point to the ear of the user. That is, the directionality formed in the medium and high frequency range may point to the ear of the user.

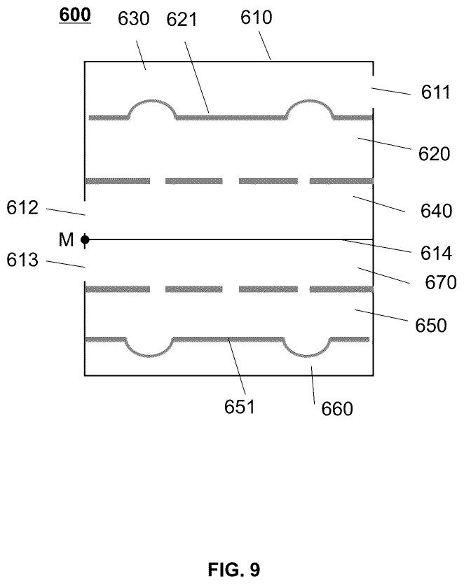

FIG. 9 is a schematic structural diagram illustrating an acoustic output device according to some embodiments of the present disclosure. In order to prevent sound waves radiated by a first loudspeaker and a second loudspeaker from interfering with each other and reduce the mutual radiation impedance, the acoustic output device may further include a configuration in which a first loudspeaker 620 and a second loudspeaker 650 do not have the same cavity, as shown in FIG. 9. For example, a housing of the acoustic output device may be provided with two accommodation spaces, and the first loudspeaker 620 and the second loudspeaker 650 may be respectively disposed in the two accommodation spaces. As another example, the first loudspeaker 620 and the second loudspeaker 650 may be disposed in the same accommodation space of the housing, but a partition may be provided between the first loudspeaker 620 and the second loudspeaker 650 such that two cavities opposite to each other of the first loudspeaker 620 and the second loudspeaker 650 may not be intercommunicated. The acoustic output device 600 shown in other embodiments is described below by taking the first loudspeaker and the second loudspeaker disposed at intervals along a vibration direction and a first diaphragm and a second diaphragm facing opposite directions as an example.

As shown in FIG. 9, an acoustic output device 600 may include a housing 610, the first loudspeaker 620, and the second loudspeaker 650. The first loudspeaker 620 may include a first diaphragm 621. A first front cavity 630 and a first rear cavity 640 may be disposed on a front side and a rear side of the first diaphragm 621, respectively. A first hole portion 611 acoustically coupled with the first front cavity 630 and a second hole portion 612 acoustically coupled with the first rear cavity 640 may be disposed on the housing 610. The first hole portion 611 and the second hole portion 612 may serve as sound outlet holes of the first loudspeaker 620 to form dual sound sources. The second loudspeaker 650 may include a second diaphragm 651. A second front cavity 660 and a second rear cavity 670 may be disposed on a front side and a rear side of the second diaphragm 651, respectively. One of the second front cavity 660 and the second rear cavity 670 may be acoustically coupled with a third hole portion 613 disposed on the housing 610, and the other of the second front cavity 660 and the second rear cavity 670 may serve as a closed cavity. The third hole portion 613 may be a hole portion different from the first hole portion 611 and the second hole portion 612. In some embodiments, a partition 614 may be disposed in the housing 610. The cavity (e.g., the second rear cavity 570 in FIG. 9) acoustically coupled with the third hole portion 613 may be separated from the first rear cavity 640 by the partition 614, and the second hole portion 612 and the third hole portion 613 may be located on both sides of the partition 614, respectively.

In some embodiments, in a target frequency range, at a far-field position in a specific direction of the acoustic output device 600, a sound pressure after the superposition of a first sound wave and a second sound wave output by the first loudspeaker 620 and a third sound wave output by the second loudspeaker 650 may be relatively small (e.g., close to zero), such that a far-field radiation from the acoustic output device 600 may be directional, thereby improving the problem of sound leakage in the far-field of the acoustic output device 600. In some embodiments, the target frequency range may include a range of 1 kHz-4 kHz, such that the acoustic output device 600 may have a relatively flat frequency response curve in a relatively wide frequency range and have a good cardioid directionality.

It should be noted that, for the acoustic output device 600, in response to manifesting the directionality, the second hole portion 612 acoustically coupled with the first rear cavity 640 of the first loudspeaker 620 and the third hole portion 613 acoustically coupled with the second rear cavity 670 of the second loudspeaker 650 may be equivalent to one hole portion. Specifically, a central position point M between the second hole portion 612 and the third hole portion 613 may be determined, and the central position point M may represent the position of the equivalent hole portion. In this case, the first front cavity 630 may serve as a front cavity of the acoustic output device 600, and the first rear cavity 640 and the cavity (e.g., the second rear cavity 670 shown in FIG. 9) acoustically coupled with the third hole portion 613 may serve as a rear cavity of the acoustic output device 600. The first hole portion 611 may serve as a front cavity sound outlet hole portion AS1 of the acoustic output device 600, and the equivalent hole portion of the second hole portion 612 and the third hole portion 613 may serve as a rear cavity sound outlet hole portion AS 2 of the acoustic output device 600. Accordingly, a direction of an extension line of a connection line between the first hole portion 611 and the equivalent hole portion (e.g., the point M) may be the specific direction.

In some embodiments, a resonance frequency of the cavity (e.g., the second front cavity 660 or the second rear cavity 670) acoustically coupled with the third hole portion 613 and a resonance frequency of the first rear cavity 640 may determine an upper frequency limit of the acoustic output device 600 for realizing the cardioid directionality. If a difference between the resonance frequency of the cavity (e.g., the second front cavity 660 or the second rear cavity 670) acoustically coupled with the third hole portion 613 and the resonance frequency of the first rear cavity 640 is too large, one of the resonance frequency of the cavity (e.g., the second front cavity 660 or the second rear cavity 670) acoustically coupled with the third hole portion 613 and the resonance frequency of the first rear cavity 640 may be too small, which may cause the upper frequency limit of the acoustic output device 600 for realizing the cardioid directionality to be too small, resulting in a frequency band range of the acoustic output device 600 for realizing the cardioid directionality being too small, and ultimately affecting the output performance of the acoustic output device 600. In some embodiments, the difference between the resonance frequency of the cavity (e.g., the second front cavity 660 or the second rear cavity 670) acoustically coupled with the third hole portion 613 and the resonance frequency of the first rear cavity 640 may not be greater than 3000 Hz. In order to make the cardioid directionality have a great upper frequency limit, in some embodiments, the difference between the resonance frequency of the cavity (e.g., the second front cavity 660 or the second rear cavity 670) acoustically coupled with the third hole portion 613 and the resonance frequency of the first rear cavity 640 may not be greater than 2500 Hz. Further, in order to make the cardioid directionality have a higher upper frequency limit, in some embodiments, the difference between the resonance frequency of the cavity (e.g., the second front cavity 660 or the second rear cavity 670) acoustically coupled with the third hole portion 613 and the resonance frequency of the first rear cavity 640 may not be greater than 2000 Hz. Preferably, the difference between the resonance frequency of the cavity (e.g., the second front cavity 660 or the second rear cavity 670) acoustically coupled with the third hole portion 613 and the resonance frequency of the first rear cavity 640 may not be greater than 1500 Hz. More preferably, the difference between the resonance frequency of the cavity (e.g., the second front cavity 660 or the second rear cavity 670) acoustically coupled with the third hole portion 613 and the resonance frequency of the first rear cavity 640 may not be greater than 1000 Hz.

In some embodiments, in order to enable the acoustic output device to realize the cardioid directionality in a sound frequency range that the human ear is sensitive to, the upper frequency limit of the cardioid directionality may not be less than 4 kHz. In some embodiments, in order to prevent the resonance frequency of the cavity from interfering with the cardioid directionality, the resonance frequency of the cavity (e.g., the second front cavity 660 or the second rear cavity 670) acoustically coupled with the third hole portion 613 may fall outside the frequency range for realizing the cardioid directionality. For example, the resonance frequency of the cavity (e.g., the second front cavity 660 or the second rear cavity 670) acoustically coupled with the third hole portion 613 may not be less than 4 kHz. In some embodiments, in order to make the upper frequency limit of the cardioid directionality larger, the resonance frequency of the cavity (e.g., the second front cavity 660 or the second rear cavity 670) acoustically coupled with the third hole portion 613 may not be less than 5 kHz.

In some embodiments, the structures of the first rear cavity 640 and the second hole portion 612 may be the same with or similar to the structure of the cavity (e.g., the second front cavity 660 or the second rear cavity 670) acoustically coupled with the third hole portion 613, and the resonance frequencies of the cavity (e.g., the second front cavity 660 or the second rear cavity 670) acoustically coupled with the third hole portion 613 and the resonance frequency of the first rear cavity 640 may be close (e.g., the difference between the resonance frequency of the cavity (e.g., the second front cavity 660 or the second rear cavity 670) acoustically coupled with the third hole portion 613 and the resonance frequency of the first rear cavity 640 may be less than 3000 Hz). In response to determining that the resonance frequency of the cavity (e.g., the second front cavity 660 or the second rear cavity 670) acoustically coupled with the third hole portion 613 is not less than 4 kHz, the volume of the cavity (e.g., the second rear cavity 570 shown in FIG. 9) acoustically coupled with the third hole portion 613 may not be greater than 0.3 cm³, and an area corresponding to the third hole portion 613 may not be less than 12 mm². In this case, the volume of the first rear cavity 640 may not be greater than 0.3 cm³, and an area corresponding to the second hole portion 612 may not be less than 12 mm².

In some embodiments, one of the second front cavity 660 and the second rear cavity 670 of the second loudspeaker 650 not acoustically coupled with the second hole portion 612 may be the closed cavity. For example, the second front cavity 660 in FIG. 9 may be the closed cavity. A resonance frequency of the closed cavity may determine a lower frequency limit of the frequency range for realizing the cardioid directionality. In some embodiments, in order to avoid the resonance frequency of the closed cavity interfering with the cardioid directionality, the resonance frequency of the closed cavity may fall outside the frequency range for realizing the cardioid directionality. For example, the resonance frequency of the closed cavity (e.g., the second front cavity 660 shown in FIG. 9) may not be greater than 1 kHz. In some embodiments, the resonance frequency of the closed cavity may be less than the lower frequency limit of the frequency range of the acoustic output device for realizing the cardioid directionality. For example, the resonance frequency of the closed cavity may not be greater than 900 Hz. In some embodiments, considering factors such as structural design and difficulty in processing and mounting, the resonance frequency of the closed cavity may not be greater than 1.1 kHz. In this case, the frequency range of the acoustic output device for realizing the cardioid directionality may be correspondingly reduced, and the lower frequency limit for realizing the cardioid directionality may be 1.1 kHz.

In some embodiments, in response to determining that the first hole portion 611 acoustically coupled with the first front cavity 630 is disposed in a corresponding region (e.g., a direction of a connection line between a geometric center of the first hole portion 611 and a geometric centroid of the first diaphragm 621 of the first loudspeaker 620 may be parallel to the vibration direction) of the housing 610 along a vibration direction of the first loudspeaker 620, the hole portions corresponding to the first rear cavity 640 and the cavity adjacent thereto (e.g., the second front cavity 660 or the second rear cavity 670) may have a plurality of arrangements. Different arrangements of the hole portions of the acoustic output device 600 are described below by taking the first loudspeaker and the second loudspeaker not having the same cavity and disposed at intervals along the vibration direction and the first diaphragm and the second diaphragm facing opposite directions as an example.

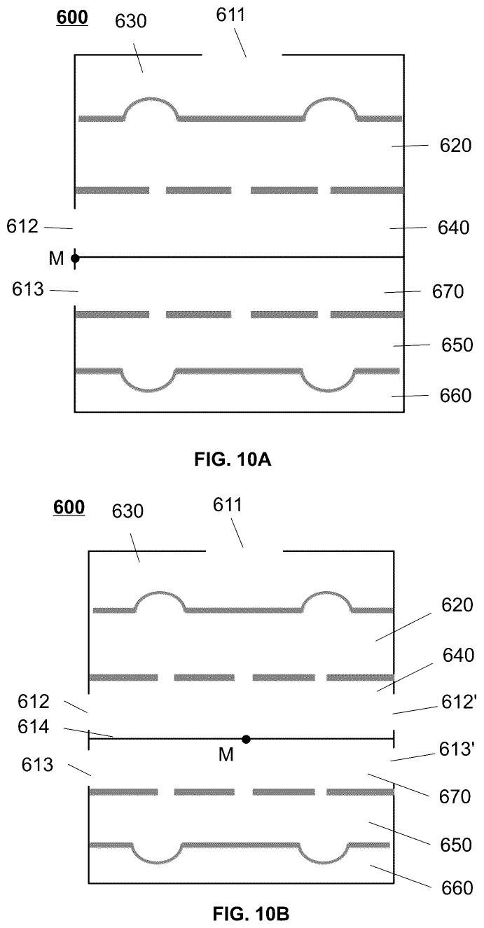

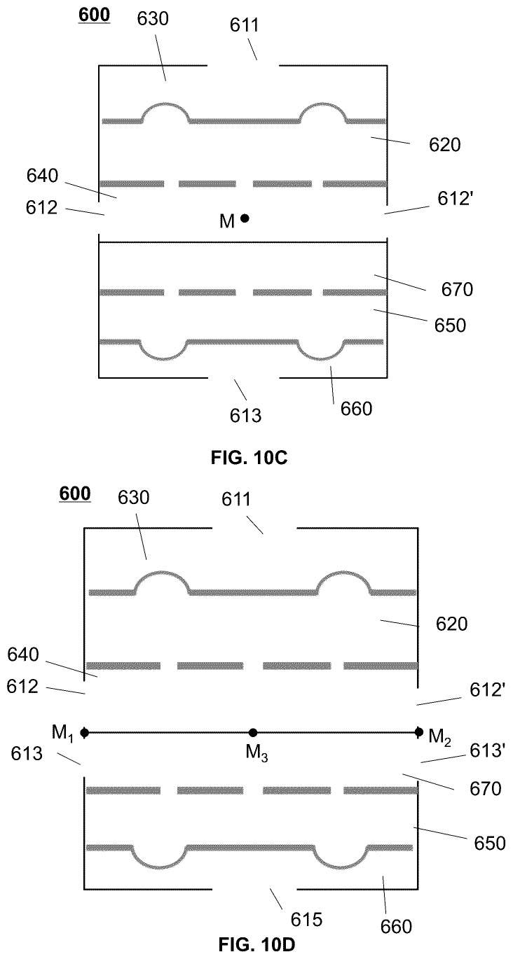

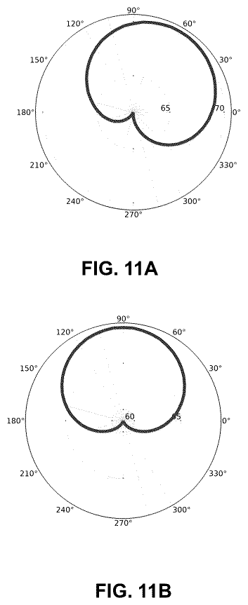

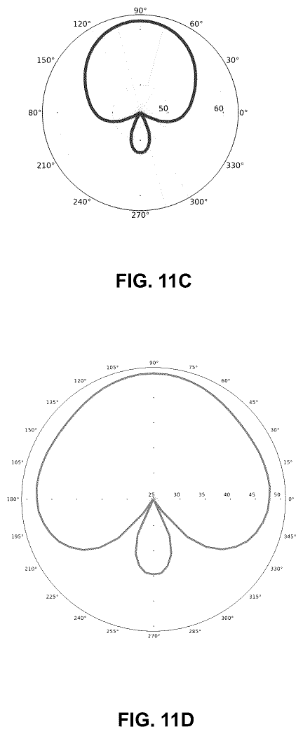

FIGS. 10A-10D are schematic diagrams illustrating acoustic output devices each of which including a sound outlet hole with different arrangements according to some embodiments of the present disclosure. FIGS. 11A-11D are schematic diagrams illustrating directionalities of a far-field radiation from the acoustic output devices in FIGS. 10A-10D. As shown in FIG. 10A and FIG. 11A, when the first hole portion 611 is arranged directly above the first loudspeaker 620 along a vibration direction (e.g., the first hole portion 611 is located on a side wall of a housing directly opposite to the first diaphragm 621, and a connection line between a geometric center of the first hole portion 611 and a geometric centroid of the first diaphragm 621 is parallel to the vibration direction of the first loudspeaker 620), and the second hole portion 612 and the third hole portion 613 are arranged on the same side wall of the housing perpendicular to the vibration direction relative to the first hole portion 611, maximum and minimum directions of a sound pressure output by the acoustic output device may be directionality directions of the acoustic output device, and the maximum direction may be opposite to the minimum direction. The minimum direction may be the specific direction, and the sound pressure at a far-field position of the acoustic output device in the specific direction (the minimum direction) may be relatively small (e.g., close to zero). The specific direction refers to a direction from a front cavity sound outlet hole (e.g., the first hole portion 611 shown in FIG. 10A) of the acoustic output device 600 to a rear cavity sound outlet hole (e.g., the equivalent hole portion point M of the second hole portion 612 and the third hole portion 613 shown in FIG. 10A).

As shown in FIG. 10B and FIG. 11B, the first hole portion 611 may be arranged directly above the first loudspeaker 620 along the vibration direction. For example, the first hole portion 611 may be located on the side wall of the housing directly opposite to the first diaphragm. The first rear cavity 640 may be acoustically coupled with two acoustic hole portions (the second hole portion 612 and the other second hole portion 612′) at the same time, and the second hole portion 612 and the other second hole portion 612′ may be respectively arranged on two side walls of the housing perpendicular to the vibration direction relative to the first hole portion 611. The second rear cavity 670 may be adjacent to the first rear cavity 640, and the second rear cavity 670 may be acoustically coupled with the third hole portion 613 and the other third hole portion 613′ at the same time. The third hole portion 613 and the other third hole portion 613′ may be respectively arranged on the two side walls of the housing perpendicular to the vibration direction relative to the first hole portion 611. In this case, in the vibration direction, the second hole portion 612 and the other second hole portion 612′ may be symmetrical with respect to the first hole portion 611 in a left-right direction, and the third hole portion 613 and the other third hole portion 613′ may be symmetrical with respect to the first hole portion 611 in the left-right direction. At this time, a direction of a connection line between an equivalent hole portion of the second hole portion 612, the other second hole portion 612′, the third hole portion 613, and the other third hole portion 613′ and the first hole portion 611 may be substantially consistent with the vibration direction. As shown in FIG. 10B, the point M shows the position of the equivalent hole portion. In this case, a connection line between the point M and the geometric center of the first hole portion 611 may be parallel to the vibration direction of the first loudspeaker 620, and the point M may be located on a midline of the connection line between the geometric center of the second hole portion 612 and the geometric center of the third hole portion 613. For example, when the second hole portion 612 and the third hole portion 613 are symmetrically arranged with respect to the partition 614, the point M may be located at the position of the geometric center of the partition 614. Directions of maximum and minimum sound pressures of the far-field radiation from the acoustic output device 600 may be directionality directions of the acoustic output device, and the direction of the maximum sound pressure may be opposite to the direction of the minimum sound pressure. The direction of the minimum sound pressure may be specific direction, e.g., a direction from a front cavity sound outlet hole (e.g., the first hole portion 611 shown in FIG. 10B) of the acoustic output device 600 to a rear cavity sound outlet hole (e.g., the equivalent hole portion point M of the second hole portion 612, the other second hole portion 612′, the third hole portion 613, and the other third hole portion 613′ shown in FIG. 10B).

As shown in FIG. 10C and FIG. 11C, the first hole portion 611 may be arranged directly above the first loudspeaker 620 along the vibration direction. For example, the first hole portion 611 may be located on the side wall of the housing directly opposite to the first diaphragm. The first rear cavity 640 may be acoustically coupled with the second hole portion 612 and the other second hole portion 612′ at the same time, and the second hole portion 612 and the other second hole portion 612′ may be respectively arranged on the two side walls of the housing perpendicular to the vibration direction relative to the first hole portion 611. The second rear cavity 670 may be adjacent to the first rear cavity 640, and the second rear cavity 670 may be a closed cavity at this time. The second front cavity 660 may be acoustically coupled with the third hole portion 613. In the vibration direction, the third hole portion 613 may be arranged on the housing opposite to the first hole portion 611, i.e., directly below a geometric centroid of the second diaphragm 651 of the second loudspeaker 650. That is, the third hole portion 613 may be located on a side wall of the housing directly opposite to a geometric centroid of the second hole portion 612. At this time, a direction of a connection line between the equivalent hole portion of the second hole portion 612 and the other second hole portion 612′ and the first hole portion 611 may be substantially consistent with the vibration direction. As shown in FIG. 10C, the point M shows the position of the equivalent hole portion. In this case, the far-field radiation from the acoustic output device 600 may have a main lobe (corresponding to the direction of the maximum sound pressure) and a side lobe. A direction of the main lobe (i.e., the direction of the maximum sound pressure) may be a direction from the equivalent hole portion point M of the second hole portion 612 and the other second hole portion 612′ to the first hole portion 611. A direction of the side lobe may be a direction from the equivalent hole portion point M of the second hole portion 612 and the other second hole portion 612′ to the third hole portion 613. Referring to FIG. 10C and FIG. 11C, it can be seen that the direction of the minimum sound pressure may be a direction from the second hole portion 612 to the third hole portion 613 and a direction from the other second hole portion 612′ to the third hole portion 613.

As shown in FIG. 10D and FIG. 11D, the first hole portion 611 may be arranged directly above the first loudspeaker 620 along the vibration direction, i.e., the first hole portion 611 may be located on a side wall of the housing opposite to the first diaphragm. The first rear cavity 640 may be acoustically coupled with the second hole portion 612 and the other second hole portion 612′ at the same time, and the second hole portion 612 and the other second hole portion 612′ may be respectively arranged on the two side walls of the housing perpendicular to the vibration direction relative to the first hole portion 611. The second rear cavity 670 may be adjacent to the first rear cavity 640. The second rear cavity 670 may be acoustically coupled with the third hole portion 613 and the other third hole portion 613′ at the same time, and the third hole portion 613 and the other third hole portion 613′ may be respectively arranged on the two side walls of the housing perpendicular to the vibration direction relative to the first hole portion 611. The second front cavity 660 may be acoustically coupled with a fourth hole portion 615. In the vibration direction, the fourth hole portion 615 may be arranged directly below the position of the housing corresponding to the first hole portion 611, i.e., the fourth hole portion 615 may be located on a side wall of the housing directly opposite to a geometric centroid of the second diaphragm. In this case, the first hole portion 611 and the equivalent hole portion of the second hole portion 612 and the other second hole portion 612′ of the first loudspeaker 620 may serve as a set of dual sound sources, and the equivalent hole portion of the third hole portion 613 and the other third hole portion 613′ and the fourth hole portion 615 of the second loudspeaker 650 may serve as dual sound sources. At this time, the second hole portion 612 and the third hole portion 613 may have an equivalent hole portion (e.g., a point M₁), the other second hole portion 612′ and the other third hole portion 613′ may have an equivalent hole portion (e.g., a point M₂), and the second hole portion 612, the other second hole portion 612′, the third hole portion 613, and the other third hole portion 613′ may have an equivalent hole portion (e.g., a point M₃). The position of point M₃ may be found in the position of the point M in FIG. 10B, which is not repeated here. A direction of a connection line between the equivalent hole portion point M₃ and the first hole portion 611 may be substantially consistent with the vibration direction. The far-field radiation from the acoustic output device 600 may have the main lobe (corresponding to the direction of the maximum sound pressure) and the side lobe. The direction of the main lobe (i.e., the direction of the maximum sound pressure) may be a direction from the equivalent hole portion point M₃ to the first hole portion 611. The direction of the side lobe may be a direction from the equivalent hole portion point M₃ to the fourth hole portion 615. Referring to FIG. 10D and FIG. 11D, it can be known that the direction of the minimum sound pressure may be a direction from the equivalent hole portion point M₁ to the fourth hole portion 615 and a direction from the equivalent hole portion point M₂ to the fourth hole portion 615. At this time, the far-field radiation from the acoustic output device 600 may realize a weak cardioid directionality, as shown in FIG. 11D. With the comparison of the cardioid directionality shown in FIG. 11A and FIG. 11B, a region of the minimum sound pressure of the far-field radiation from the acoustic output device 600 shown in FIG. 11D may be relatively narrow, sound pressure levels in the direction of the minimum sound pressure and directions on both sides of the direction of the minimum sound pressure may be relatively large, and a sound pressure level in a direction (a direction of 0°-180°) near the direction of the maximum sound pressure may be relatively uniform. In some embodiments, the acoustic output device 600 shown in FIG. 10D may be suitable for use in a scenario where a uniform radiation is required in a half space.

In some embodiments, the arrangement of the sound outlet hole portion of the acoustic output device is not limited to the above modes, and the sound outlet hole portion may be arranged according to actual needs. In some embodiments, the first hole portion corresponding to the first front cavity of the first loudspeaker may be arranged to correspond to a listening position (e.g., arranged toward an external ear canal of the user or arranged close to the external ear canal of the user) of an ear of a user in a wearing state. The sound outlet hole portion corresponding to the first rear cavity of the first loudspeaker and the sound outlet hole portion of the second loudspeaker should be as far away from the first hole portion as possible to reduce the interference of other sound outlet hole portions on the first sound wave radiated by the first hole portion. In some embodiments, a region (e.g., a 30° fan-shaped region 10 cm away from the ear of the user) where the acoustic output device needs to reduce sound leakage may be determined according to an actual application scenario, the listening quality of the acoustic output device, or the need to reduce the sound leakage, so as to determine the direction of the maximum sound pressure and the direction of the minimum sound pressure of the directionality of the far-field radiation from the acoustic output device, thereby determining the setting position of the corresponding sound outlet hole portion.

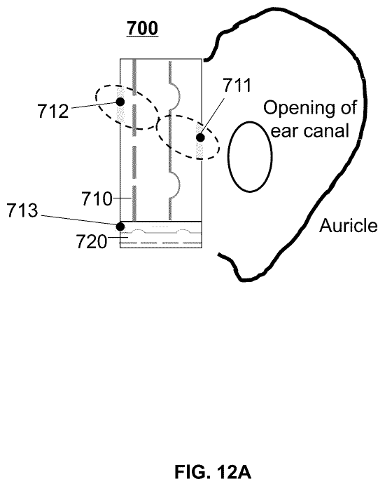

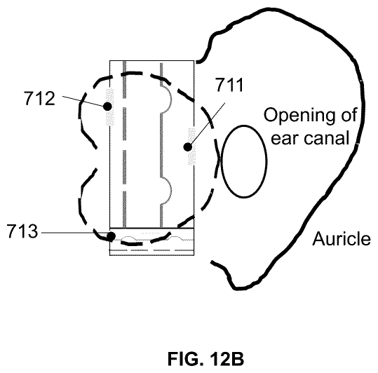

In order to reduce the overall size of the acoustic output device, the size of the loudspeaker as a single sound source should not be too large, otherwise it may cause a fundamental resonance frequency (i.e., the resonance frequency of the closed cavity of the loudspeaker of the single sound source) of the loudspeaker of a single sound source to be relatively high, and the lower frequency limit of the frequency range of the acoustic output device for realizing the cardioid directionality is difficult to dive to the frequency band of human voice. FIGS. 12A-12B are schematic diagrams illustrating directionalities of a far-field radiation from acoustic output devices each of which including a hole portion with an exemplary arrangement position according to some embodiments of the present disclosure. As shown in FIGS. 12A-12B, an acoustic output device 700 may include a first loudspeaker 710 and a second loudspeaker 720. A front cavity and a rear cavity of the first loudspeaker 710 may be acoustically coupled with a first hole portion 711 and a second hole portion 712, respectively to serve as dual sound sources. One cavity of the second loudspeaker 720 may be closed, and the other cavity of the second loudspeaker 720 may be acoustically coupled with a third hole portion 713 to serve as a single sound source. In order to make the sound leakage of the acoustic output device 700 at a side of the head of the user always small in the whole frequency band, as shown in FIG. 12A and FIG. 12B, compared with the first loudspeaker 710 as a dual sound source, a size of the second loudspeaker 720 as a single sound source may be relatively small, and a length of the second loudspeaker 720 may be close to a thickness of the first loudspeaker 710. The first hole portion 711 may be disposed toward an opening of an ear canal of the use. The second hole portion 712 and the third hole portion 713 may both be disposed away from the first hole portion 711. In this case, in a frequency range of middle and low frequency bands (e.g., below 1 kHz), since an output sound pressure level of the single sound source is less than that of the dual sound sources, the output of the single sound source may be ignored at this time, and the acoustic output device 700 may be similar to the dual sound sources operating alone, realizing an “8”-shaped dual sound source directionality to reduce the sound leakage, as shown in FIG. 12A. In a frequency range of medium and high frequencies (e.g., 1 kHz-4 kHz), the single sound source and the dual sound sources may cooperate to realize the cardioid directionality, as shown in FIG. 12B.

In some embodiments, a closed cavity (e.g., the second front cavity 560 shown in FIG. 5A, the second rear cavity 570 shown in FIG. 5B, etc.) of the second loudspeaker of the acoustic output device not acoustically coupled with the hole portion may be filled with an acoustic granular material, increasing a virtual volume of the closed cavity and lowering a resonance frequency of the closed cavity, thereby reducing the lower frequency limit of the acoustic output device for realizing the cardioid directionality, and increasing a frequency range for realizing the cardioid directionality.

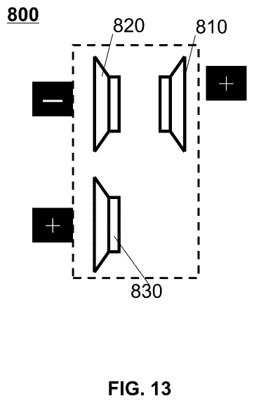

FIG. 13 is a schematic diagram illustrating another acoustic output device according to some embodiments of the present disclosure. As shown in FIG. 13, in some embodiments, an acoustic output device 800 may include a first loudspeaker 810, a second loudspeaker 820, and a third loudspeaker 830 which are separately arranged. The first loudspeaker 810 may be configured to radiate a first sound wave. The second loudspeaker 820 may be configured to radiate a second sound wave. The first sound wave and the second sound wave radiated from the first loudspeaker 810 and the second loudspeaker 820, respectively, may satisfy a certain phase and amplitude condition e.g., the same amplitude and opposite phase), thereby forming a dual sound source structure. The third loudspeaker 830 may be configured to radiate a third sound wave, and the third sound wave radiated from the third loudspeaker 830 may satisfy the certain phase and amplitude condition with the second sound wave radiated from the second loudspeaker 820 and the first sound wave radiated from the first loudspeaker 810 at a far-field position in a specific direction of the acoustic output device 800, such that the third sound wave, the first sound wave and the second sound wave are destructively superposed at the far-field position, thereby realizing a far-field directionality of the acoustic output device 800. In some embodiments, the first loudspeaker 810, the second loudspeaker 820, and the third loudspeaker 830 may be loudspeakers of which the front cavity or the rear cavity is closed and sound is only output from the unclosed cavity of the front cavity and the rear cavity. In some embodiments, the acoustic output device 800 may include a sound box.

In some embodiments, an output of the acoustic output device may be measured using a test microphone. In some embodiments, a test microphone may be disposed at the far-field position in the specific direction of the acoustic output device and a corresponding far-field position in an opposite direction of the specific direction of the acoustic output device, respectively, to measure sound pressure levels at the two far-field positions and obtain a difference between the sound pressure levels at the two corresponding far-field positions. By comparing an absolute value of the difference between the sound pressure levels with a preset sound pressure level threshold, it can be determined whether the acoustic output device has the directionality in the specific direction and the opposite direction of the specific direction.

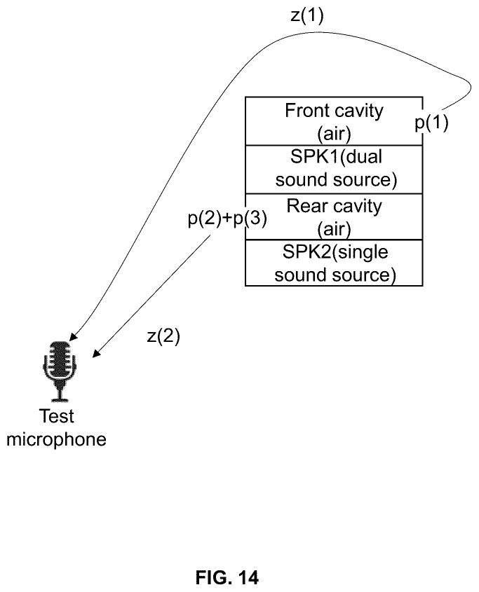

FIG. 14 is a schematic diagram illustrating an acoustic transmission of an acoustic output device including a second loudspeaker according to some embodiments of the present disclosure. Referring to FIG. 14, in some embodiments, one of test microphones may be disposed at a far-field position in a specific direction of an acoustic output device. In some embodiments, the far-field position of the acoustic output device refers to a position at a distance greater than a preset distance threshold from the acoustic output device, such as a position at a distance greater than 2.5 cm from the acoustic output device. In some embodiments, when a frequency range is within a range of 1 kHz-4 kHz, the far-field position of the acoustic output device refers to a position at a distance greater than 5.5 cm from the acoustic output device. In some embodiments, the test microphone may be disposed at a position 30 cm away from the acoustic output device in a specific direction. The specific direction refers to a direction from a front cavity sound outlet hole portion (e.g., a first hole portion) to a rear cavity sound outlet hole portion (e.g., a second hole portion) of the acoustic output device and a nearby direction thereof. In some embodiments, the front cavity of the acoustic output device refers to a first front cavity of a first loudspeaker, and the rear cavity of the acoustic output device refers to an equivalent cavity of a first rear cavity of the first loudspeaker and an output cavity of a second loudspeaker or the same cavity thereof. In response to determining that the acoustic output device is in a wearing state, the specific direction may also be a direction in which the acoustic output device is away from an ear of a user. In some embodiments, in order to realize a directionality, an absolute value of a difference between sound pressure levels measured by the test microphones disposed at the corresponding two far-field positions in the specific direction and an opposite direction of the specific direction of the acoustic output device may not less than a preset sound pressure level threshold. The sound pressure measured by the test microphone disposed at the far-field position in the specific direction may be relatively small (e.g., close to zero).

In some embodiments, the sound pressures received by the test microphones may include two sets of sound waves. One of the two sets of sound waves may be a sound wave (e.g., a first sound wave) radiated from a hole portion acoustically coupled with the front cavity, and a transfer function of the sound wave is denoted as z(1). The other of the two sets of sound waves may be a sound wave (e.g., a second sound wave and a third sound wave) radiated from a hole portion acoustically coupled with the rear cavity, and a transfer function of the sound wave is denoted as z(2). In order to make the far-field radiation from the acoustic output device directional, it is necessary to make the two sets of sound waves received by the test microphones destruct each other. For example, sound pressure amplitudes of the two sets of sound waves at the positions of the test microphones may be equal and phases of the two sets of sound waves at the positions of the test microphones may be opposite. A receiving signal p_{mic} of the test microphone may be expressed as:

$${p}_{mic} = p ( 1 ) * z ( 1 ) + [ p ( 2 ) + p ( 3 ) ] * z ( 2 ) = 0 \qquad ( 1 )$$

where p(1) denotes a sound pressure radiated from a dual sound source (i.e. the first loudspeaker, such as SPK 1 shown in FIG. 14) in the front cavity, p(2) denotes a sound pressure radiated from the dual sound source (i.e. the first loudspeaker, such as SPK1 shown in FIG. 14) in the rear cavity, and p(3) denotes a sound pressure radiated p(3) from a single sound source (i.e. the second loudspeaker, such as SPK2 shown in FIG. 14) in the rear cavity.

In some embodiments, p(1), p(2), p(3) need to avoid mutual interference in measurement. Therefore, when the p(1) is measured, the first loudspeaker may operate and the second loudspeaker may be turned off. At the same time, the hole portion (e.g. the second hole portion) connected with the rear cavity may be temporarily blocked using cotton, rubber, etc., and the p(1) may be measured using the other test microphone disposed in or near the hole portion (e.g., the first hole portion) connected with the front cavity (e.g., within a distance interval of 2 mm-3 mm). When the p(2) is measured, the first loudspeaker may operate and the second loudspeaker may be turned off. At the same time, the hole portion (e.g. the first hole portion) connected with the front cavity may be temporarily blocked using cotton, rubber, etc., and the p(2) may be measured using the other test microphone disposed in or near the hole portion (e.g., the second hole portion) connected with the rear cavity of the first loudspeaker. When the p(3) is measured, the second loudspeaker may operate and the first loudspeaker may be turned off. The p(3) may be measured using the other test microphone disposed in or near the hole portion (e.g., the second hole portion or the third hole hereinafter, etc.) connected with the rear cavity of the second loudspeaker.

In some embodiments, a baffle with a relatively large size (e.g., a diameter of 1 m) may be disposed at a peripheral side of the acoustic output device. The baffle may be disposed around the acoustic output device, and the baffle may be tightly connected to the acoustic output device. A sound outlet hole portion (i.e., the hole portion connected with the front cavity) of the front cavity and a sound outlet hole portion (i.e., the hole portion connected with the rear cavity) of the rear cavity may be respectively located on both sides of the baffle. By setting the baffle, the mutual interference between the first sound wave radiated from the sound outlet hole portion of the front cavity and the second sound wave and the third sound wave radiated from the sound outlet hole portion of the rear cavity may be greatly weakened or even isolated, thereby improving the test accuracy of p(1), p(2), and p(3). In some embodiments, when the baffle is set, the first loudspeaker may operate and the second loudspeaker may be turned off. At the same time, the test microphones may be disposed at the hole portion connected with the front cavity and the hole portion connected with the rear cavity, respectively, and the p(2) and the p(1) may be measured simultaneously.

According to the distribution rate of convolution, the formula (1) may be expressed as:

$${p}_{mic} = [ p ( 1 ) * z ( 1 ) + p ( 2 ) * z ( 2 ) ] + p ( 3 ) * z ( 2 ) = 0 \qquad ( 2 )$$

where [p(1)*z(1)+p(2)*z(2)] denotes sound pressures of sound waves (e.g., the first sound wave and the second sound wave) radiated from the dual sound source (i.e., the first loudspeaker, such as SPK1 in FIG. 14) at the test microphone, and p(3)*z(2) denotes a sound pressure of a sound wave (e.g., the third sound wave) radiated from the single sound source (i.e., the second loudspeaker, such as SPK2 in FIG. 14) at the microphone. Therefore, by adjusting a first electrical signal and a second electrical signal, the dual sound source (i.e., the first loudspeaker) and the single sound source (i.e., the second loudspeaker) may be respectively excited, and the sound pressure amplitude and phase of the sound waves radiated from the two sound sources reaching the test microphones may be recorded. By adjusting an amplitude and a phase of the second electrical signal driving the single sound source (i.e., the second loudspeaker, SPK2) and/or an amplitude and a phase of the first electrical signal driving the dual sound sources (i.e., the first loudspeaker, SPK1), the sound pressure amplitudes of the sound wave radiated from the single sound source (i.e., the second loudspeaker) and the sound wave (i.e., the sound wave obtained by superposition of the first sound wave and the second sound wave) radiated from the dual sound source (i.e., the first loudspeaker) at the test microphones may be equal (i.e., sound pressure level amplitudes are equal) and the phases may be opposite, such that the sound pressure of the acoustic output device at the far-field position in the specific direction may be zero, the sound pressure level of the acoustic output device at the far-field position in the specific direction may be zero, and the absolute value of the difference between the sound pressure levels of the acoustic output device at the far-field position in at least one pair of opposite directions may not be less than a preset sound pressure level threshold, thereby realizing the directionality of the far-field radiation from the acoustic output device.

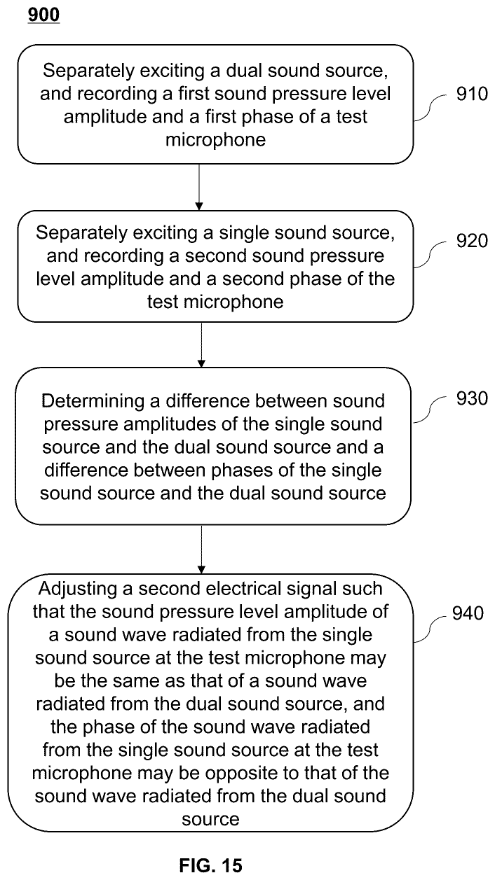

FIG. 15 is a flowchart illustrating an exemplary process of adjusting a second electrical signal according to some embodiments of the present disclosure. As shown in FIG. 15, a process 900 may include the following operations.

In 910, a dual sound source may be excited separately, and a first sound pressure level amplitude and a first phase of a test microphone may be recorded.

In some embodiments, the dual sound source may be a first loudspeaker. The test microphone may be disposed at a far-field position in a specific direction of an acoustic output device. In some embodiments, the specific direction refers to a direction from a sound outlet hole portion of a front cavity to a sound outlet hole portion of a rear cavity and a nearby direction within a specified direction range. In this case, the first sound pressure level amplitude and the first phase measured by the test microphone may be the first sound pressure level amplitude and the first phase after a first sound wave and a second sound wave generated by the first loudspeaker are superposed at the test microphone.

In some embodiments, the first loudspeaker may operate while a second loudspeaker may not operate by providing a first electrical signal only to the first loudspeaker and not providing a second electrical signal to the second loudspeaker, thereby achieving separate excitation of the dual sound source.

In 920, a single sound source may be excited separately, and a second sound pressure level amplitude and a second phase of the test microphone may be recorded.

In some embodiments, the single sound source may be the second loudspeaker. The test microphone may be disposed at the far-field position in the specific direction of the acoustic output device, which is the same as the position of the test microphone in the operation 910. At this time, the sound pressure level amplitude and the phase measured by the test microphone may be the second sound pressure level amplitude and second phase of a third sound wave generated by the second loudspeaker at the test microphone.

In some embodiments, the second loudspeaker may operate while the first loudspeaker may not operate by providing the second electrical signal only to the second loudspeaker and not providing the first electrical signal to the first loudspeaker, thereby achieving separate excitation of the single sound source.

In 930, a difference between sound pressure amplitudes of the single sound source and the dual sound source and a difference between phases of the single sound source and the dual sound source may be determined.

The second sound pressure level amplitude of the single sound source measured by the test microphone may be compared with the first sound pressure level amplitude of the dual sound source to obtain the difference between the sound pressure level amplitudes of the single sound source and the dual sound source. The second phase of the single sound source measured by the test microphone may be compared with the first phase of the dual sound source to obtain the difference between the phases of the single sound source and the dual sound source.

In 940, a second electrical signal may be adjusted such that the sound pressure level amplitude of a sound wave radiated from the single sound source at the test microphone may be the same as that of a sound wave radiated from the dual sound source, and the phase of the sound wave radiated from the single sound source at the test microphone may be opposite to that of the sound wave radiated from the dual sound source.

The second electrical signal that drives the single sound source may be adjusted according to the difference between the sound pressure amplitudes and the difference between the phases of the single sound source and the dual sound source obtained in the operation 930 such that the sound pressure level amplitude of the sound wave radiated from the single sound source at the test microphone may be the same as that of the sound wave radiated from the dual sound source, and the phase of the sound wave radiated from the single sound source at the test microphone may be the opposite to that of the sound wave radiated from the dual sound source. Thus a third sound wave radiated from the single sound and the first sound wave and the second sound wave radiated from the dual sound source are destructively superposed at the position of the test microphone, thereby making the far-field radiation from the acoustic output device directional (e.g., the cardioid directionality), and reducing the far-field sound leakage of the acoustic output device.

In some embodiments, the first electrical signal driving the dual sound source may be adjusted according to the difference between the sound pressure amplitudes and the difference between the phases of the single sound source and the dual sound source obtained in the operation 930, such that the sound pressure level amplitudes of the sound waves radiated from the single sound source and the dual sound source at the test microphone may be the same and the phases may be opposite, thereby making the far-field radiation from the acoustic output device directional (e.g., the cardioid directionality), and reducing the far-field sound leakage of the acoustic output device.

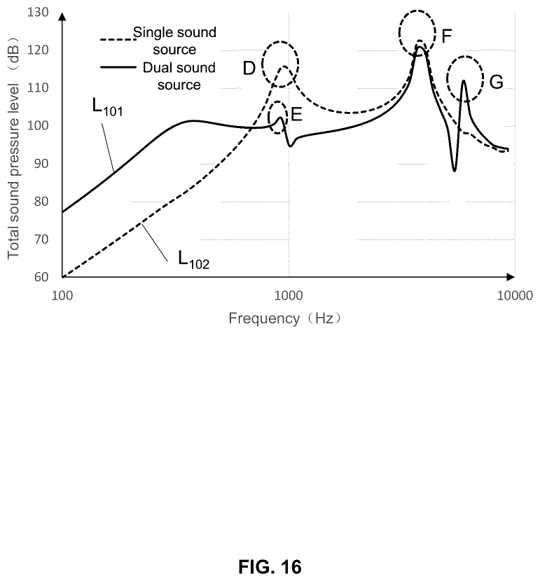

FIG. 16 is a schematic diagram illustrating frequency response curves when a single sound source and a dual sound source are excited separately according to some embodiments of the present disclosure. Merely by way of example, a single sound source (e.g., a second loudspeaker) and a dual sound source (e.g., a first loudspeaker) may share a rear cavity (e.g., the structure shown in FIG. 5A) of an acoustic output device, and a volume of the rear cavity of the acoustic output device may be equal to a volume of a front cavity. In this case, a hole portion connected with the front cavity may be a first hole portion, and a hole portion connected with the rear cavity may be a second hole portion (e.g., the structure shown in FIG. 5A). An area of the first hole portion may be equal to that of the second hole portion. An amplitude of a second electrical signal that excites the single sound source and an amplitude of a first electrical signal that excites the dual sound sources may both be 1 V, and phases may both be 0°. As shown in FIG. 16, under the above condition, a curve L₁₀₁ denotes a frequency response curve measured by a test microphone when the dual sound source is excited separately, and a curve L₁₀₂ denotes a frequency response curve measured by the test microphone when the single sound source is excited separately.

Under the above condition, a difference between the sound pressure level amplitudes and a difference between the phases of the single sound source and the dual sound source at the position of the test microphone (e.g., a far-field of the acoustic output device) at different frequencies may be measured by the operation 900. Meanwhile, the difference between the sound pressure level amplitudes of the single sound source and the dual sound source at the position of the test microphone (e.g., the far-field of the acoustic output device) at different frequencies may be determined according to the comparison between the curve L₁₀₁ and the curve L₁₀₂ in FIG. 16.

In some embodiments, by adjusting the amplitude and the phase of the first electrical signal and the second electrical signal to make the first electrical signal and the second electrical signal have a certain difference in the amplitude and/or the phase within a target frequency range, such that a sound wave (e.g., a third sound wave) generated by the single sound source (e.g., the second loudspeaker) and a sound wave (e.g., a first sound wave and a second sound wave) generated by the dual sound source (e.g., first loudspeaker) may be superposed with each other, thereby making a far-field radiation from the acoustic output device directional. In some embodiments, the target frequency range may include a range of 100 Hz-10 kHz. In some embodiments, the acoustic output device composed of the single sound source and the dual sound source may achieve sound leakage reduction in a wide band of 100 Hz-10 kHz. The target frequency range may include a first frequency range. The first frequency range may include some medium and high frequency bands, such as 800 Hz-10000 Hz. In the first frequency range, the acoustic output device may achieve sound leakage reduction using the principle of cardioid directionality. For example, the far-field radiation from the acoustic output device may present the cardioid directionality. The target frequency range may include a second frequency range. The second frequency range may include some medium and low frequency bands. In the second frequency range, such as 100 Hz-800 Hz, the acoustic output device may achieve sound leakage reduction using the principle of dual sound source directionality. More descriptions may be found in FIG. 1 and related descriptions thereof.

In some embodiments, the acoustic output device may have the dual sound source directionality in the range of 100 Hz-800 Hz. That is, in the range of 100 Hz-800 Hz, a difference between a sound pressure level of a sound wave (e.g., a sound wave obtained by superposed of a first sound wave and a second sound wave) output by a first loudspeaker at a hole portion (e.g., a second hole portion) acoustically coupled with a first rear cavity and a sound pressure level of a third sound wave output by a second loudspeaker at a hole portion (e.g., a third hole portion) coupled thereto may not be less than 6 dB. In some embodiments, when a sound pressure radiated from the single sound source in the rear cavity is much less than a sound pressure radiated from the dual sound source in the rear cavity, i.e., p(3)<<p(2), the sound pressure level radiated from single sound source may be extremely small compared to the sound pressure level radiated from the dual sound source, and the acoustic output device may achieve the dual sound source directionality. For example, when p(2)/p(3)≥2, it is considered that p(3)<<p(2). In this case, a difference between the sound pressure levels radiated from the dual sound source and the single sound source in the rear cavity may be greater than or equal to 6 dB, i.e., the difference between the sound pressure level corresponding to p(2) and the sound pressure level corresponding to p(3) may be greater than or equal to 6 dB, and the acoustic output device can achieve the dual sound source directionality.

In summary, in the frequency band of 100 Hz-800 Hz, when the same electrical signal (e.g., the amplitudes of the first electrical signal and the second electrical signal are the same and the phases of the first electrical signal and the second electrical signal are the same) is provided to the single sound source and the dual sound source, since the front cavity of the single sound source (e.g., the second loudspeaker) is closed, only the rear cavity is communicated the outside air, and the air cannot flow freely, it is difficult for the single sound source to output a low-frequency sound wave at the hole portion acoustically coupled with the rear cavity. Therefore, in this frequency band, the difference between the sound pressure level of the sound wave output by the dual sound source (e.g., the first loudspeaker) at the hole portion acoustically coupled with the rear cavity and the sound pressure level of the sound wave output by the single sound source (e.g., the second loudspeaker) at the hole portion acoustically coupled with the rear cavity may be greater than or equal to 6 dB. In this case, the acoustic output device may have good dual sound source directionality, thereby realizing the effect of medium-and-low-frequency leakage reduction. In some embodiments, in order to realize that the difference between the sound pressure level of the sound wave output by the dual sound source (e.g., the first loudspeaker) at the hole portion acoustically coupled with the rear cavity and the sound pressure level of the sound wave output by the single sound source (e.g., the second loudspeaker) at the hole portion acoustically coupled with the rear cavity in the range of 100 Hz-800 Hz is greater than or equal to 6 dB, a mode of reducing an amplitude of the second electrical signal driving the single sound source (e.g., the second loudspeaker) in the range of 100 Hz-800 Hz may also be adopted. For example, in the range of 100 Hz-800 Hz, the amplitude of the second electrical signal may be 0. For example, the second electrical signal may not be provided to the single sound source in the range of 100 Hz-800 Hz. In some embodiments, in a wearing state, the hole portion acoustically coupled with the first front cavity of the first loudspeaker may be disposed close to an ear of a user, and the hole portion acoustically coupled with the first rear cavity may be disposed away from the ear of the user. A direction from the hole portion acoustically coupled with the first rear cavity to the hole portion acoustically coupled with the first front cavity may point to the ear of the user. For example, the dual sound source directionality formed in the low-frequency range may point to the ear of the user.

In some embodiments, in a frequency range of 1 kHz-10 kHz, in order to make the first sound wave, the second sound wave, and the third sound wave superposed with each other at the far-field position in the specific direction of the acoustic output device to make the sound pressure level at the far-field position zero, such that the absolute value of the difference between the sound pressure levels of the acoustic output device at the far-field position in at least one pair of opposite directions is not less than a preset sound pressure level threshold, and the far-field radiation from the acoustic output device is directional, the amplitude and the phase of the first electrical signal and the second electrical signal may be adjusted. In some embodiments, referring to FIG. 16, since a resonance frequency of a resonance peak E of the dual sound source is close to a resonance frequency of a resonance peak D of the single sound source, the dual sound source and the single sound source may have a first resonance frequency (i.e., a frequency corresponding to the resonance peak D). The back cavity shared by the single sound source and the dual sound source may have a second resonance frequency (e.g., a frequency corresponding to the resonance peak F). As shown in FIG. 16, frequency response curves of the single sound source and the dual sound source have a flat region between the first resonance frequency and the second resonance frequency. In some embodiments, a frequency band between the first resonance frequency and the second resonance frequency may include a range of 1 kHz-4 kHz. In some embodiments, the first resonance frequency may be located near 1 kHz, and the second resonance frequency may be located near 4 kHz, such that the frequency response curves of the single sound source and the dual sound source may have a wider flat region, thereby improving the acoustic output performance of the acoustic output device. In some embodiments, by adjusting the second electrical signal and/or the first electrical signal, the far-field radiation from the acoustic output device may have the cardioid directionality between the first resonance frequency and the second resonance frequency (e.g., 1 kHz-4 kHz). In some embodiments, in a frequency band (e.g., 4 kHz-10 kHz) greater than the second resonance frequency, by adjusting the second electrical signal and/or the first electrical signal, the far-field radiation from the acoustic output device may also have the cardioid directionality. In some embodiments, in the wearing state, the hole portion acoustically coupled with the first front cavity of the first loudspeaker may be disposed close to the ear of the user. The hole portion acoustically coupled with the first rear cavity and the hole portion of the second loudspeaker outputting the third sound wave may be disposed away from the ear of the user. The hole portion acoustically coupled with the first rear cavity and the hole portion of the second loudspeaker outputting the third sound wave may have an equivalent hole portion. A direction from the equivalent hole portion to the hole portion acoustically coupled with the first front cavity may point to the ear of the user, i.e., the directionality formed in the medium-and-high frequency range may point to the ear of the user.

In some embodiments, a difference between the phases of the second electrical signal and the first electrical signal may not be less than 150° between the first resonance frequency and the second resonance frequency. In some embodiments, in the range of 1 kHz-4 kHz, the difference between the phases of the second electrical signal and the first electrical signal may not be less than 150°. For example, in the situation shown in FIG. 16, when the amplitude of the first electrical signal remains constant at 1 V (i.e., 1000 mV) and the phase remains constant at 0°, in order to make the sound pressure level at the far-field position in the specific direction of the acoustic output device zero, such that the absolute value of the difference between the sound pressure levels at the far-field position of the acoustic output device in the at least one pair of opposite directions is not less than the preset sound pressure level threshold, the second electrical signal may be modulated. In the range of 1 kHz-4 kHz, the phase and the amplitude of a modulated second electrical signal at each frequency may be expressed as follows. At a frequency of 1 kHz, the amplitude of the second electrical signal is 27.5 mV, and the phase is 250°. At a frequency of 1.5 kHz, the amplitude of the second electrical signal is 344.3 mV, and the phase is 225°. At a frequency of 2 kHz, the amplitude of the second electrical signal is 472 mV, and the phase is 229°. At a frequency of 3 kHz, the amplitude of the second electrical signal is 738.7 mV, and the phase is 202°. At a frequency of 4 kHz, the amplitude of the second electrical signal is 708.76 mV, and the phase is 179°. It should be noted that, in some embodiments, the sound pressure at the far-field position in the specific direction of the acoustic output device may be small but not zero. Therefore, the corresponding amplitude and the phase of the second electrical signal may have a deviation of 10%. For example, at the frequency of 1 kHz, the amplitude of the second electrical signal may be 27.5*(1±0.1) mV, and the phase may be 250*(1±0.1)°. For example, the amplitude of the second electrical signal may be in a range of 24.75 mV-30.25 mV, and the phase may be in a range of 225°-247.5°.

As shown in FIG. 16, the single sound source (e.g., the second loudspeaker) may have the first resonance frequency (e.g., the frequency corresponding to the resonance peak D). When passing through the first resonance frequency, the phase of the sound wave radiated from the single sound source may reverse. Correspondingly, the resonance peak E of the dual sound source near the first resonance frequency may be generated by a diaphragm of the single sound source that does not operate and serve as a passive diaphragm when the dual sound source operates. Therefore, at the resonance frequency of the resonance peak E, the sound wave radiated from the dual sound source may not reverse. Accordingly, before and after the first resonance frequency, in order to ensure that the sound wave radiated from the single sound source and the sound wave radiated from the dual sound source maintain the opposite phases in the far-field, it is necessary to compensate the phase of the sound wave radiated from the single sound source. In some embodiments, at two frequencies before and after the first resonance frequency, the difference between the phases of the second electrical signal is not less than 100°. The phase of the second electrical signal at a frequency before the first resonance frequency may be a phase before the compensation; the phase of the second electrical signal at a frequency after the first resonance frequency may be a phase after compensation. In some embodiments, at the two frequencies before and after the first resonance frequency, the difference between the phases of the second electrical signal may be in a range of 100°-240°. In some embodiments, at the two frequencies before and after the first resonance frequency, the difference between the phases of the second electrical signal may be in a range of 120°-220°. In some embodiments, at the two frequencies before and after the first resonance frequency, the difference between the phases of the second electrical signal may be in a range of 140°-180°. In some embodiments, at the two frequencies before and after the first resonance frequency, the difference between the phases of the second electrical signal may be in a range of 150°-160°.

It should be noted that if the phase of the sound wave radiated from only one of the dual sound source and the single sound source changes by 180° near a certain resonance frequency, in order to avoid such a change causing the sound waves in the far-field to no longer destruct each other, it is necessary to change the electrical signal of one of the dual sound source or the single sound source before and after the resonance frequency (e.g., reverse 180° or close to 180°). However, since the difference between the phases of the first electrical signal and the second electrical signal at each frequency may be different, after the phase of one of the electrical signals is compensated accordingly, the final difference between the phases of the first electrical signal and the second electrical signal may not be strictly 180°, but close to 180° or approximately 180°.

In some embodiments, in an actual product, the specifications of the loudspeakers of the acoustic output device may be different, the sizes of the front and rear cavities may be different, the areas and the depths of the corresponding sound outlet portions may be different, and the structural shapes of the front and rear cavities may be different, resulting in the position of a resonance peak (e.g., the resonance peak D and the resonance peak F of the single sound source, the resonance peak G of the dual sound source, etc.) may shift. Therefore, the value of the difference between the phases of the second electrical signal may be different at two frequencies in different frequency ranges before and after the resonance peak.

In some embodiments, at two frequencies of 100 Hz before and after the first resonance frequency, the difference between the phases of the second electrical signal may be in a range of 100°-240°. In some embodiments, since the size of the single sound source may be different, at two frequencies of 500 Hz before and after the first resonance frequency, the difference between the phases of the second electrical signal may be in a range of 120°-220°. In some embodiments, since the structure of the single sound source may be different, at two frequencies of 1000 Hz before and after the first resonance frequency, the difference between the phases of the second electrical signal may be in a range of 140°-180°.

In some embodiments, it can be seen from FIG. 16 that the first resonance frequency (the frequency corresponding to the resonance peak D) may be in a range of 800 Hz-1.2 kHz, and may be located near 1 kHz. In some embodiments, at the frequency of 800 Hz and 1.2 kHz, the difference between the phases of the second electrical signal may be in a range of 120°-220° (e.g., 130°-180°). In some embodiments, since the size of the single sound source may be different, at the frequency of 900 kHz and 1.1 kHz, the difference between the phases of the second electrical signal may be in a range of 120°-150° (e.g., 130°-150°). In some embodiments, since the size of the single sound source may be different, at the frequency of 950 Hz and 1 kHz, the difference between the phases of the second electrical signal may be in a range of 140°-170° (e.g., 145°-155°).

It can be seen from FIG. 16 that in some embodiments, the rear cavity shared by the single sound source and the dual sound source may have the second resonance frequency (e.g., the frequency corresponding to the resonance peak F). Before and after the second resonance frequency, the phase of the sound wave radiated from the single sound source and the phase of the sound wave radiated from the dual sound source may not all reverse by 180°. By observing the vibration mode, it is found that the phase of the sound wave radiated from the single sound source and the phase of the sound wave radiated from the dual sound source change from moving toward each other to relative movement. Therefore, before and after the second resonance frequency, it is still necessary to compensate the phase of the sound wave radiated from one of the single sound source or the dual sound source. In some embodiments, in a frequency band between the two frequencies before and after the second resonance frequency, the difference between the phases of the second electrical signal may not be less than 100°. In some embodiments, at the two frequencies before and after the second resonance frequency, the difference between the phases of the second electrical signal may be in a range of 100°-260°. In some embodiments, at the two frequencies before and after the second resonance frequency, the difference between the phases of the second electrical signal may be in a range of 120°-170°. In some embodiments, at the two frequencies before and after the second resonance frequency, the difference between the phases of the second electrical signal may be in a range of 140-160°.

In some embodiments, at two frequencies of 100 Hz before and after the second resonance frequency, the difference between the phases of the second electrical signal may be in a range of 100°-260°. In some embodiments, since the size of the rear cavity may be different, at two frequencies of 300 Hz before and after the second resonance frequency, the difference between the phases of the second electrical signal may be in a range of 130°-180°. In some embodiments, since the area of the sound outlet hole portion of the rear cavity may be different, at two frequencies of 500 Hz before and after the second resonance frequency, the difference between the phases of the second electrical signal may be in a range of 160°-170°. In some embodiments, since the depth of the sound outlet hole portion of the rear cavity may be different, at two frequencies of 700 Hz before and after the second resonance frequency, the difference between the phases of the second electrical signal may be in a range of 140°-180°. In some embodiments, since the structure of the rear cavity may be different, resulting in different volumes, at two frequencies of 700 Hz before and after the second resonance frequency, the difference between the phases of the second electrical signal may be in a range of 170°-240°.

In some embodiments, it can be seen from FIG. 16 that the second resonance frequency (the frequency corresponding to the resonance peak F) may be in a range of 3 kHz-5 kHz, and may be located near 4 kHz. In some embodiments, at the frequency of 3 kHz and 5 kHz, the difference between the phases of the second electrical signal may be in a range of 100°-240° (e.g., 138°-160°). In some embodiments, since the volume of the rear cavity may be different, at the frequency of 3.1 kHz and 4.8 kHz, the difference between the phases of the second electrical signal may be in a range of 120°-140° (e.g., 130°-140°). In some embodiments, since the area of the sound outlet hole portion of the rear cavity may be different, at the frequency of 3.5 kHz and 4.5 kHz, the difference between the phases of the second electrical signal may be in a range of 160°-170° (e.g., 162°-168°). In some embodiments, since the depth of the sound outlet hole portion of the rear cavity may be different, at the frequency of 3.8 kHz and 4.2 kHz, the difference between the phases of the second electrical signal may be in a range of 155°-180° (e.g., 160°-170°).

As shown in FIG. 16, in some embodiments, the front cavity of the dual sound source (e.g., the first loudspeaker) may have a third resonance frequency (i.e., the frequency corresponding to the resonance peak G). When passing through the third resonance frequency, the phase of the sound wave radiated from the dual sound source may reverse. Correspondingly, when the single sound source is excited alone, the resonance peak (not shown in the figure) of the single sound source near the third resonance frequency may be generated by the diaphragm of the dual sound source that does not operate as the passive diaphragm, but the phase of the sound wave radiated from the single sound source near the third resonance frequency may not reverse. Therefore, in order to ensure that the sound wave radiated from the single sound source and the sound wave radiated from the dual sound source maintain the opposite phases in the far-field, it is necessary to compensate the phase of the sound wave radiated from the single sound source. In a frequency band between the two frequencies before and after the third resonance frequency, the second electrical signal needs to be compensated. In some embodiments, at the two frequencies before and after the third resonance frequency, the difference between the phases of the second electrical signal may not be greater than 100°. In some embodiments, at the two frequencies before and after the third resonance frequency, the difference between the phases of the second electrical signal may be in a range of 100°-240°. In some embodiments, at two frequencies before and after the third resonance frequency, the difference between the phases of the second electrical signal may be in a range of 170°-200°.

In some embodiments, at two frequencies of 100 Hz before and after the third resonance frequency, the difference between the phases of the second electrical signal may be in a range of 175°-185°. In some embodiments, since the size of the front cavity may be different, at two frequencies of 200 Hz before and after the third resonance frequency, the difference between the phases of the second electrical signal may be in a range of 170°-200°. In some embodiments, since the volume of the front cavity may be different, at two frequencies of 600 Hz before and after the third resonance frequency, the difference between the phases of the second electrical signal may be in a range of 150°-180°. In some embodiments, since the area and/or the depth of the sound outlet hole portion of the front cavity may be different, at two frequencies of 1000 Hz before and after the third resonance frequency, the difference between the phases of the second electrical signal may be in a range of 120°-200°.

In some embodiments, it can be seen from FIG. 16 that the third resonance frequency (the frequency corresponding to the resonance peak G) may be in a range of 5 kHz-8 kHz. In some embodiments, at the frequency of 5 kHz and 8 kHz, the difference between the phases of the second electrical signal may be in a range of 100°-200° (e.g., 115°-160°). In some embodiments, since the volume of the front cavity may be different, at the frequency of 5.1 kHz and 7.5 kHz, the difference between the phases of the second electrical signal may be in a range of 110°-150° (e.g., 130°-140°). In some embodiments, since the area of the sound outlet hole portion of the front cavity may be different, at the frequency of 5.4 kHz and 7 kHz, the difference between the phases of the second electrical signal may be in a range of 140°-170° (e.g., 150°-159°). In some embodiments, since the depth of the sound outlet hole portion of the front cavity may be different, at the frequency of 5.8 kHz and 6 kHz, the difference between the phases of the second electrical signal may be in a range of 170°-180° (e.g., 170°-176°).

By adjusting the amplitude and the phase of the second electrical signal driving the single sound source and/or the first electrical signal driving the dual sound source at multiple frequencies through the single sound source and dual sound source, the second electrical signal and the first electrical signal may have corresponding difference in the amplitude and the phase respectively, such that the sound pressure of the sound wave radiated from the single sound source and the sound pressure of the sound wave radiated from the dual sound source at the test microphone may be relatively small (e.g., close to zero), making the formula (1) valid.

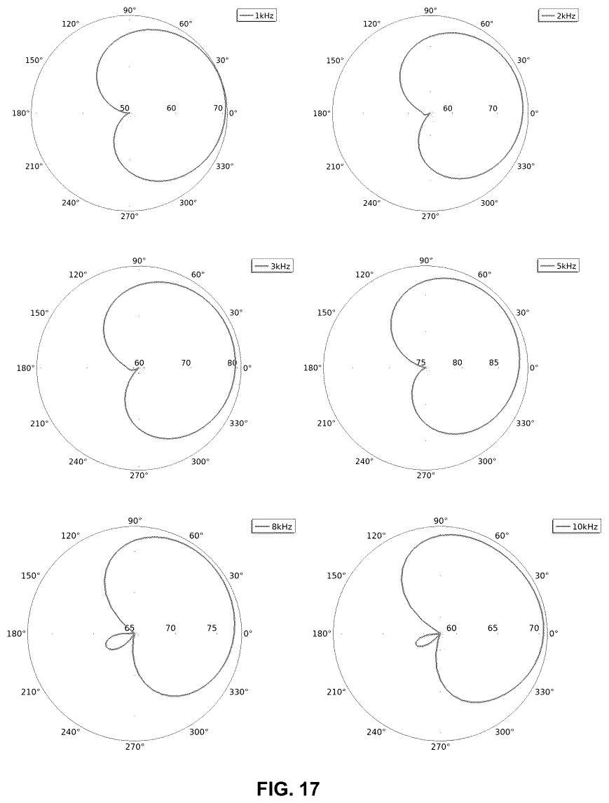

FIG. 17 is a schematic diagram illustrating a directionality of a far-field radiation from an acoustic output device after a second electrical signal is adjusted according to some embodiments of the present disclosure. As shown in FIG. 17, at frequencies of 1 kHz, 2 kHz, 3 kHz, 5 kHz, 8 kHz, and 10 kHz, by setting the second electrical signal, an output (e.g., a phase and/or an amplitude of the output) of a single sound source (e.g., a second loudspeaker) may be adjusted such that there is almost no output at a far-field position in a specific direction of the acoustic output device, and in this case, the far-field radiation of the acoustic output device presents the directionality. A 0° direction indicates a direction in which the acoustic output device points to an opening of an ear canal of a user, such as a direction (as shown in the direction X1 in FIG. 4) from a sound outlet hole portion AS2 (e.g., a second hole portion) of a rear cavity of the acoustic output device to a sound outlet hole portion AS1 (e.g., a first hole portion) of a front cavity. A 180° direction indicates a direction in which the acoustic output device is away from the opening of the ear canal of the user, such as a direction (as shown in the direction X1′ in FIG. 4) from the sound outlet hole portion AS₁ (e.g., the first hole portion) of the front cavity of the acoustic output device to the sound outlet hole portion AS₂ (e.g., the second hole portion) of the rear cavity. At a frequency of 1 kHz, the far-field radiation from the acoustic output device presents the cardioid directionality, a maximum point of a sound field may be near 15°, a minimum point of the sound field may be near 180°, and an absolute value of a difference between sound pressure levels in the two directions may be about 22.5 dB. At a frequency of 2 kHz, the far-field radiation from the acoustic output device presents the cardioid directionality, the maximum point of the sound field may be near 15°, the minimum point of the sound field may be near 200°, and the absolute value of the difference between the sound pressure levels in the two directions may be about 20.8 dB. At a frequency of 3 kHz, the far-field radiation from the acoustic output device presents the cardioid directionality, the maximum point of the sound field may be near 15°, the minimum point of the sound field may be near 190°, and the absolute value of the difference between the sound pressure levels in the two directions may be about 19.9 dB. At a frequency of 5 kHz, the far-field radiation from the acoustic output device presents the cardioid directionality, the maximum point of the sound field may be near 30°, the minimum point of the sound field may be near 200°, and the absolute value of the difference between the sound pressure levels in the two directions may be about 19.6 dB. At the frequency of 8 kHz, the far-field radiation from the acoustic output device may be cardioid and include a main lobe and a side lobe. A direction (i.e., a direction of the maximum point of the sound field) of the main lobe may be around 40°, and a direction of the side lobe may be around 200°. Minimum values may be provided between the side lobe and the main lobe. The minimum values may be around 150° and 250°, respectively, and an absolute value of a difference between sound pressure levels of one of the minimum values and the maximum value and an absolute value of a difference between sound pressure levels of the other of the minimum values and the maximum value may be approximately 16.6 dB and 12.9 dB, respectively. At a frequency of 10 kHz, the far-field radiation from the acoustic output device may be cardioid and include the main lobe and the side lobe. The direction of the main lobe (i.e., the direction of the maximum point of the sound field) may be around 10°, and the direction of the side lobe may be around 200°. Minimum values may be provided between the side lobe and the main lobe. The minimum values may be around 160° and 240°, respectively, and the absolute value of the difference between the sound pressure levels of one of the minimum values and the maximum value and the absolute value of the difference between the sound pressure levels of the other of the minimum values and the maximum value may be approximately 32.4 dB and 19.93 dB, respectively. Therefore, at the frequencies of 1 kHz, 2 kHz, 3 kHz, 5 kHz, 8 kHz, and 10 kHz, the directionality direction of the far-field radiation from the acoustic output device may be from 180° and the nearby direction thereof to the direction of 0° and the nearby direction thereof, i.e., the direction (the direction X1 shown in FIG. 4) from the sound outlet hole portion AS₂ (e.g., the second hole portion) of the rear cavity of the acoustic output device to the sound outlet hole portion AS₁ (e.g., the first hole portion) of the front cavity and the nearby direction thereof.

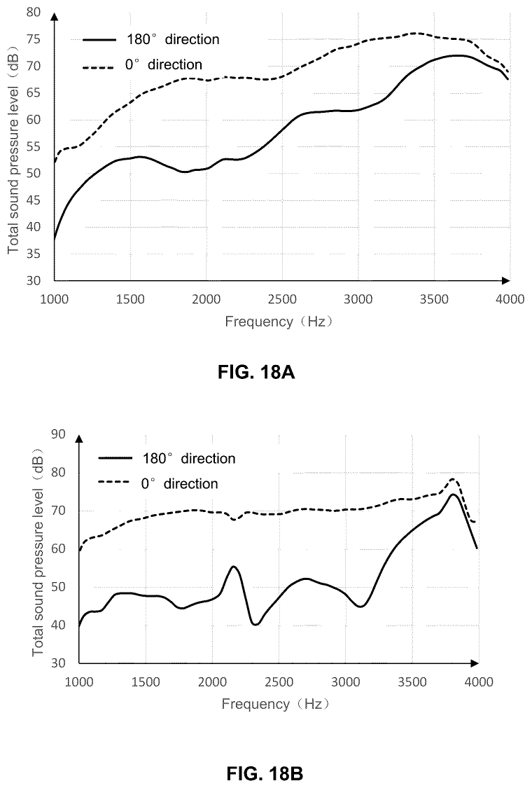

FIGS. 18A-18B are schematic diagrams illustrating test curves of directionalities of acoustic output devices according to some embodiments of the present disclosure. A test signal used in FIG. 18A may be a white noise signal, and a test signal used in FIG. 18B may be a sweep frequency signal. A frequency range of the white noise signal and the sweep frequency signal may be within a range of 1 kHz-4 kHz, so as to test the directionality of the acoustic output device in the frequency range of 1 kHz-4 kHz. In some embodiments, the white noise signal refers to a signal that includes all frequencies in the frequency range of 1 kHz-4 kHz at any time. The white noise signal may simulate a complex signal output. The sweep frequency signal refers to a signal that gradually changes from 1 kHz to 4 kHz. The sweep frequency signal may only include a single frequency signal at any time. The sweep frequency signal may simulate a simple signal input. As shown in FIG. 18A and FIG. 18B, a dotted line denotes a frequency response curve of the acoustic output device in a 0° direction, and a solid line denotes a frequency response curve of the acoustic output device in a 180° direction. In some embodiments, an output sound pressure level of the acoustic output device in the 0° direction may be measured by a test microphone disposed near (e.g., 10 cm away from the sound outlet hole portion of the front cavity) the sound outlet hole portion (e.g., the first hole portion) of the front cavity; an output sound pressure level of the acoustic output device in the 180° direction may be measured by a test microphone disposed near (e.g., 10 cm away from the sound outlet hole portion of the rear cavity) the sound outlet hole portion (e.g., the second hole portion and/or the third hole portion) of the rear cavity. In some embodiments, the test microphones, the sound outlet hole portion of the front cavity, and the sound outlet hole portion of the rear cavity may be arranged on a straight line, and the straight line may be a straight line where the 0° direction and the 180° direction are located. As shown in FIG. 18A, when the test signal is the white noise signal, an absolute value of a difference between the sound pressure levels of the acoustic output device in the 0° direction and the 180° direction may be within a range of 8 dB-18 dB, and the acoustic output device may have a good cardioid directionality. As shown in FIG. 18B, when the test signal is the sweep frequency signal, the absolute value of the difference between the sound pressure levels of the acoustic output device in the 0° direction and the 180° direction may be within a range of 15 dB-25 dB, and the acoustic output device may have a good cardioid directionality.

It should be noted that the above content is only for the adjustment of the second electrical signal. In some embodiments, the corresponding adjustment may also be made only to the first electrical signal. In some embodiments, the corresponding adjustment may be made to both the first electrical signal and the second electrical signal. The specific manner of the adjustment to the electrical signal is described below by taking the adjustment of the second electrical signal as an example.

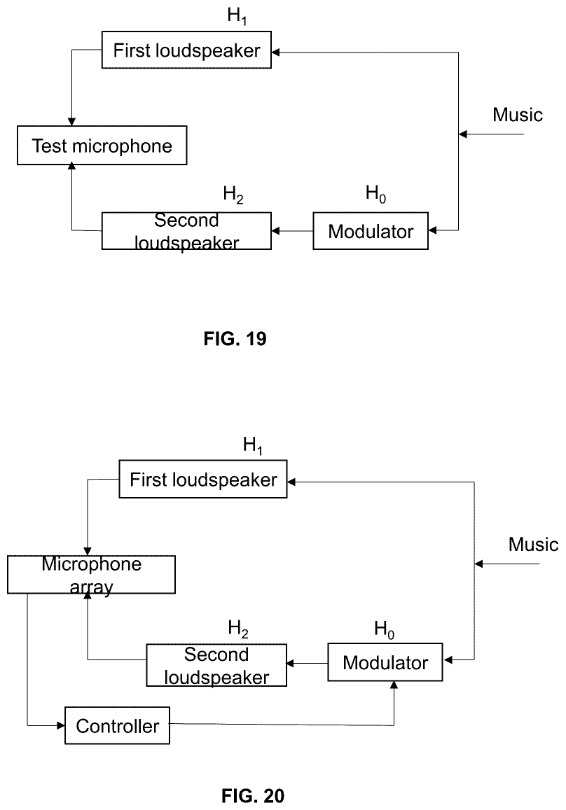

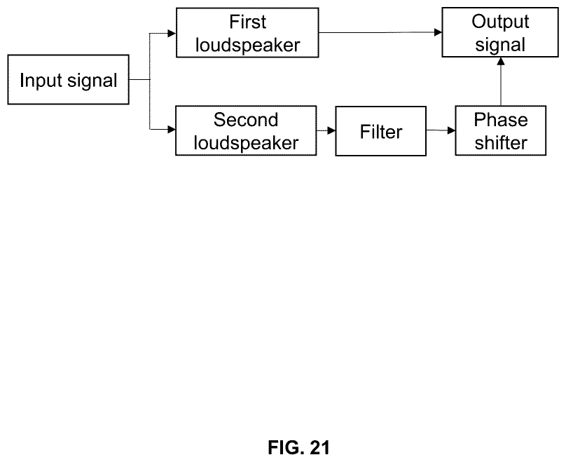

FIG. 19 is a schematic diagram illustrating an equivalent model of an acoustic output device adjusted according to a preset algorithm according to some embodiments of the present disclosure. As shown in FIG. 19, in some embodiments, the acoustic output device may further include a modulator. The modulator may be configured to modulate a second electrical signal driving a second loudspeaker according to a preset algorithm, such that in a target frequency range, a third sound wave output by the second loudspeaker and a first sound wave and a second sound wave output by a first loudspeaker may be destructively superposed at a remote position in a specific direction of the acoustic output device, an absolute value of a difference between sound pressure levels of the acoustic output device at a far-field position in at least one pair of opposite directions may not be less than a preset sound pressure level threshold (e.g., the sound pressure of the acoustic output device at the far-field position in the specific direction may be small (e.g., close to zero)). In some embodiments, the preset algorithm may include a preset amplitude-frequency adjustment mode, such as a preset amplitude modulation scheme, a preset frequency (phase) modulation scheme, etc. More descriptions regarding amplitude modulation and phase modulation may be found in the related descriptions of FIG. 21, which are not repeated here.

In some embodiments, the principle of FIG. 19 may be similar to the principle shown in FIG. 14. The preset algorithm (e.g., a modulation function Hoof the modulator) for modulating the second electrical signal may be determined by a sound pressure measured by a test microphone disposed at the far-field position in the specific direction of the acoustic output device. When the acoustic output device operates, the modulator may directly modulate the second electrical signal according to the preset algorithm.

In some embodiments, a signal Music may include a first electrical signal driving the first loudspeaker and a second electrical signal driving the second loudspeaker. The first loudspeaker and the second loudspeaker may be configured to receive the first electrical signal and the second electrical signal in the signal Music, respectively, and output a sound to the space. The test microphone may be disposed at the far-field position in the specific direction of the acoustic output device and may measure a sound pressure of a sound at the position. When a sound pressure signal received by the test microphone is zero, it means that the sound pressure of the sound (i.e., a sound obtained by superposition of the first sound wave, the second sound wave, and the third sound) radiated from the first loudspeaker and the second loudspeaker to a target position (i.e., the far-field position in the specific direction of the acoustic output device) is zero, i.e.:

$$Music \cdot {H}_{1} + Music \cdot {H}_{0} \cdot {H}_{2} = 0 \qquad ( 3 )$$

Where H₁ and H₂ denote transfer functions of the sound wave (e.g., the first sound wave and the second sound wave) generated by the first loudspeaker to the test microphone and the third sound wave generated by the second loudspeaker to the test microphone, respectively; and H₀ denotes a transfer function of the modulator configured to modulate the second electrical signal driving the second loudspeaker.

The transfer function H₁ (i.e., a first transfer function) of the first loudspeaker may be tested by turning off the second loudspeaker:

$${H}_{1} = {Mic}^{′} / {Music}^{′} \qquad ( 4 )$$

where Music′ denotes a signal (e.g., the first electrical signal) input when the second loudspeaker is turned off, and Mic′ denotes a sound pressure signal received at the test microphone when the second loudspeaker is turned off.

Similarly, the transfer function H₂ (i.e., a second transfer function) of the second loudspeaker may be tested by turning off the first loudspeaker:

$${H}_{2} = {Mic}^{″} / {Music}^{″} \qquad ( 5 )$$

where Music″ denotes a signal (e.g., the second electrical signal) input when the first loudspeaker is turned off, and Mic″ denotes a sound pressure signal received at the test microphone when the first loudspeaker is turned off.

The transfer function H₀ of the modulator may be obtained according to the formulas 3)-(5):

$${H}_{0} = - \frac{{H}_{1}}{{H}_{2}} = - \frac{Mic ′ / Music ′}{{Mic}^{″} / {Music}^{″}} \qquad ( 6 )$$

Therefore, for different frequencies, the transfer function H₀ of the modulator may be determined according to the formula (6), and the set modulator may be applied to the acoustic output device, such that the acoustic output device can achieve the effect of sound leakage reduction at different frequencies. In some embodiments, in response to determining that a plurality of test microphones are provided, a sound output by the first loudspeaker and the second loudspeaker at any position in the space may be measured or simulated. Therefore, by setting the test microphones in at least one pair of opposite directions, a difference between sound pressure levels of far-field radiated sounds from the acoustic output device in the at least one pair of opposite directions may be measured. For different frequencies, the transfer function of the modulator may be adjusted according to the formulas (3)-(6) such that the difference between the sound pressure levels of the far-field radiated sounds from the acoustic output device in the at least one pair of opposite directions may not be less than the preset sound pressure level threshold.

In some embodiments, the test microphone may include a microphone array. By measuring the sound at the far-field position in the specific direction of the acoustic output device through the microphone array, the accuracy of the measurement data can be improved.

FIG. 20 is a schematic diagram illustrating an equivalent model of an acoustic output device adjusted according to an active algorithm according to some embodiments of the present disclosure. As shown in FIG. 20, in some embodiments, the acoustic output device may further include a controller, a modulator, and a microphone array. The microphone array may be disposed on a housing of the acoustic output device. The microphone array may be configured to estimate a sound signal at a preset position. The preset position may include a far-field position in a specific direction of the acoustic output device. In some embodiments, the preset position may also include far-field positions in at least one pair of opposite directions of the acoustic output device. In some embodiments, the controller may be configured to determine the active algorithm (e.g., an active amplitude-frequency adjustment mode) according to a sound signal collected by the microphone array. The modulator may be configured to dynamically modulate a second electrical signal driving a second loudspeaker according to the active algorithm (e.g., the active amplitude-frequency adjustment mode) determined by the controller, such that in target frequency range, a third sound wave output by the second loudspeaker and a first sound wave and a second sound wave output by a first loudspeaker may be destructively superposed at the far-field position in the specific direction of the acoustic output device, thus an absolute value of a difference between sound pressure levels of the acoustic output device at the far-field positions in the at least one pair opposite directions may not be less than a preset sound pressure level threshold, thereby realizing the directionality of a far-field radiation from the acoustic output device.

In some embodiments, when the acoustic output device is worn by a user, a transfer function corresponding to the first loudspeaker may change from an initial value H₁ to H₁′, and a transfer function corresponding to the second loudspeaker may change from an initial value H₂ to H₂′. H₁′ and H₂′ corresponding to different users may be different. Accordingly, the formula (3) may be expressed as:

$$Music \cdot {H}_{1}^{′} + Music \cdot {H}_{0} \cdot {H}_{2}^{′} = 0 \qquad ( 7 )$$

In some embodiments, for variable H₁′ and H₂′, the controller may adjust H₀ according to a sound wave collected by the microphone array such that the formula (7) is valid, thereby realizing the effect of sound leakage reduction in the specific direction. The adjusted H₀ may be determined according to the formula (6):

$${H}_{0} = - \frac{{H}_{1}^{′}}{{H}_{2}^{′}} \qquad ( 8 )$$

According to the method described in FIG. 20, H₀ may be adjusted in real time based on the collected sound wave to realize the effect of real-time sound leakage reduction, such that the absolute value of the difference between the sound pressure levels of the acoustic output device at the far-field positions in the at least one pair of opposite directions may not be less than the preset sound pressure level threshold, thereby realizing the directionality of the far-field radiation from the acoustic output device.

In some embodiments, for acoustic output devices of different structures, the transfer function H₁ of the first loudspeaker and the transfer function H₂ of the second loudspeaker may be different. Accordingly, the adjustment mode of the transfer function H₀ of the corresponding modulator may also be different. For example, the corresponding adjustment mode may be different when the first loudspeaker and the second loudspeaker are disposed in the same cavity. As another example, the corresponding adjustment mode may be different when a distance between a sound outlet hole (e.g., a second hole portion 912) of a rear cavity of the first loudspeaker and a sound outlet hole (e.g., a third hole portion 913) of the second loudspeaker is different. As another example, the corresponding adjustment mode may be different when an acoustic impedance at a sound outlet hole (e.g., the first hole portion 911, the second hole portion 912, the third hole portion 913, etc.) is different.

FIG. 21 is a schematic block illustrating an amplitude and phase adjustment algorithm according to some embodiments of the present disclosure. Referring to FIG. 21, taking the adjustment of a second electrical signal driving a second loudspeaker as an example, an input signal may include an initial first electrical signal and an initial second electrical signal. The initial first electrical signal and the initial second electrical signal may be respectively input into a first loudspeaker and the second loudspeaker. The first loudspeaker and the second loudspeaker may vibrate to generate sound waves that are superposed with each other. The transfer function H₀ of a modulator may be determined by the principle shown in FIG. 19 and/or FIG. 20. An amplitude adjustment value and a phase adjustment value for the initial second electrical signal may be determined by the transfer function H₀. In some embodiments, the amplitude of the initial second electrical signal may be adjusted by a filter. In some embodiments, the filter may adopt an infinite impulse response (IIR) filter. The IIR filter has a small amount of computation and good real-time performance. In some embodiments, the filter may also adopt a finite impulse response (FIR) filter. The FIR filter has good stability and controllable phase, and enables a synchronous input signal to be synchronously output while performing amplitude selection to avoid signal distortion. In some embodiments, the phase of the initial second electrical signal may be adjusted by a phase shifter. In some embodiments, the initial second electrical signal may be adjusted by the filter and the phase shifter synchronously; or the initial second electrical signal may be adjusted by one of the filter and the phase shifter first, and then the initial second electrical signal may be adjusted by the other of the filter and the phase shifter. An adjusted second electrical signal may be combined with the initial first electrical signal to be output as an output signal. A sound wave generated by an adjusted second electrical signal driving the second loudspeaker may be destructively superposed with the sound wave generated by the initial first electrical signal driving the first loudspeaker at a target position (e.g., at a far-field position in a specific direction of the acoustic output device), such that an absolute value of a difference between sound pressure levels of the acoustic output device at the far-field position in at least one pair of opposite directions may not be less than a preset sound pressure level threshold (e.g., not less than 6 dB), thereby realizing the directionality of the acoustic output device.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure and are within the spirit and scope of the exemplary embodiments of this disclosure.

Moreover, certain terminology has been used to describe embodiments of the present disclosure. For example, the terms “one embodiment,” “an embodiment,” and “some embodiments” mean that a particular feature, structure, or feature described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures, or features may be combined as suitable in one or more embodiments of the present disclosure.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, is not to be interpreted as reflecting an intention that the claimed subject matter requires more features than are expressly recited in each claim. Rather, claimed subject matter may lie in less than all features of a single foregoing disclosed embodiment.

In some embodiments, numbers describing the number of ingredients and attributes are used. It should be understood that such numbers used for the description of the embodiments use the modifier “about”, “approximately”, or “substantially” in some examples. Unless otherwise stated, “about”, “approximately”, or “substantially” indicates that the number is allowed to vary by ±20%. Correspondingly, in some embodiments, the numerical parameters used in the description and claims are approximate values, and the approximate values may be changed according to the required features of individual embodiments. In some embodiments, the numerical parameters should consider the prescribed effective digits and adopt the method of general digit retention. Although the numerical ranges and parameters used to confirm the breadth of the range in some embodiments of the present disclosure are approximate values, in specific embodiments, settings of such numerical values are as accurate as possible within a feasible range.

For each patent, patent application, patent application publication, or other materials cited in the present disclosure, such as articles, books, specifications, publications, documents, or the like, the entire contents of which are hereby incorporated into the present disclosure as a reference. The application history documents that are inconsistent or conflict with the content of the present disclosure are excluded, and the documents that restrict the broadest scope of the claims of the present disclosure (currently or later attached to the present disclosure) are also excluded. It should be noted that if there is any inconsistency or conflict between the description, definition, and/or use of terms in the auxiliary materials of the present disclosure and the content of the present disclosure, the description, definition, and/or use of terms in the present disclosure is subject to the present disclosure.

Finally, it should be understood that the embodiments described in the present disclosure are only used to illustrate the principles of the embodiments of the present disclosure. Other variations may also fall within the scope of the present disclosure. Therefore, as an example and not a limitation, alternative configurations of the embodiments of the present disclosure may be regarded as consistent with the teaching of the present disclosure. Accordingly, the embodiments of the present disclosure are not limited to the embodiments introduced and described in the present disclosure explicitly.

1. An acoustic output device, comprising:
a housing;
a first loudspeaker disposed in the housing, wherein the first loudspeaker includes a first diaphragm, and in the housing, a first front cavity and a first rear cavity are respectively disposed on a front side and a rear side of the first diaphragm, and the first front cavity and the first rear cavity are acoustically coupled with two hole portions disposed on the housing, respectively, to output a first sound wave and a second sound wave having a phase difference; and
a second loudspeaker disposed in the housing, wherein the second loudspeaker includes a second diaphragm, and in the housing, a second front cavity and a second rear cavity are respectively disposed on a front side and a rear side of the second diaphragm, and only one of the second front cavity and the second rear cavity is acoustically coupled with a hole portion disposed on the housing to output a third sound wave, wherein in a target frequency range, the third sound wave, the first sound wave and the second sound wave are destructively superposed at a far-field position in a specific direction of the acoustic output device.

2. The acoustic output device of claim 1, wherein the first loudspeaker is driven by a first electrical signal, the second loudspeaker is driven by a second electrical signal, and in a target frequency range, the first electrical signal and the second electrical signal have a difference in amplitude and/or phase, the superposition of the first sound wave, the second sound wave, and the third sound wave generates a directional far-field radiation from the acoustic output device.

3. The acoustic output device of claim 1, wherein a vibration direction of the first diaphragm and a vibration direction of the second diaphragm are the same, and the first diaphragm and the second diaphragm are arranged at intervals along the vibration direction or a direction perpendicular to the vibration direction.

4. The acoustic output device of any claim 1, wherein the first front cavity and the first rear cavity are respectively coupled with a first hole portion and a second hole portion disposed on the housing, and one of the second front cavity and the second rear cavity shares the same cavity with the first rear cavity, and the second front cavity or the second rear cavity that shares the same cavity with the first rear cavity outputs the third sound wave through the second hole portion.

5. The acoustic output device of claim 4, wherein a resonance frequency of the same cavity is not less than 4 kHz.

6. The acoustic output device of claim 4, wherein a volume of the same cavity is not greater than 0.28 cm³, and an area of the second hole portion is not less than 20 mm².

7. The acoustic output device of claim 5, wherein a resonance frequency of the second rear cavity or the second front cavity that is not acoustically coupled with the second hole portion is not greater than 1 kHz.

8. The acoustic output device of claim 5, wherein in a target frequency range and under the driving of the same electrical signal, at a far-field position in a specific direction of the acoustic output device, a difference between the superposition of sound pressure levels of the first sound wave and the second sound wave output by the first loudspeaker and a sound pressure level of the third sound wave output by the second loudspeaker is less than 14 dB.

9. The acoustic output device of claim 8, wherein the target frequency range includes a range of 1 kHz-4 kHz.

10. The acoustic output device of claim 8, wherein a direction of an extension line of a connection line between the first hole portion and the second hole portion is the specific direction.

11. The acoustic output device of claim 1, wherein the first front cavity and the first rear cavity are respectively coupled with a first hole portion and a second hole portion disposed on the housing, and one of the second front cavity and the second rear cavity is coupled with a third hole portion disposed on the housing, the third hole portion being a hole portion different from the first hole portion and the second hole portion.

12. The acoustic output device of claim 11, wherein the second front cavity or the second rear cavity that is acoustically coupled with the third hole portion has a resonance frequency, the first rear cavity acoustically coupled with the second hole portion has a resonance frequency, and a difference between the resonance frequency of the second front cavity or the second rear cavity that is acoustically coupled with the third hole portion and the resonance frequency of the first rear cavity acoustically coupled with the second hole portion is not greater than 3000 Hz.

13. The acoustic output device of claim 11, wherein a resonance frequency of the second front cavity or the second rear cavity that is acoustically coupled with the third hole portion is not less than 4 kHz.

14. The acoustic output device of claim 11, wherein a resonance frequency of the second rear cavity or the second front cavity that is not acoustically coupled with the third hole portion is not greater than 1 kHz.

15. The acoustic output device of claim 11, wherein in a target frequency range and under the driving of the same electrical signal, at a far-field position in a specific direction of the acoustic output device, a difference between the superposition of sound pressure levels of the first sound wave and the second sound wave output by the first loudspeaker and a sound pressure level of the third sound wave output by the second loudspeaker is less than 14 dB, the target frequency range including a range of 1 kHz-4 kHz.

16. The acoustic output device of claim 15, wherein the second hole portion and the third hole portion form an equivalent hole portion, and a direction of an extension line of a connection line between the first hole portion and the equivalent hole portion is the specific direction.

17. The acoustic output device of claim 1, wherein in a range of 100 Hz-800 Hz, a difference between a sound pressure level of a sound wave output by the first loudspeaker at a hole portion of the two hole portions that is acoustically coupled with the first rear cavity and a sound pressure level of the third sound wave output by the second loudspeaker at the hole portion acoustically coupled therewith is not less than 6 dB.

18. The acoustic output device of claim 1, wherein in a wearing state, a hole portion of the two hole portions that is acoustically coupled with the first front cavity of the first loudspeaker is arranged closer to an ear of a user, a hole portion of the two hole portions that is acoustically coupled with the first rear cavity and the hole portion of the second loudspeaker outputting the third sound wave are arranged further away from the ear of the user, the hole portion of the two hole portions that is acoustically coupled with the first rear cavity and the hole portion of the second loudspeaker outputting the third sound wave form an equivalent hole portion, and a direction from the equivalent hole portion to the hole portion of the two hole portions that is acoustically coupled with the first front cavity points to the ear of the user.

19. The acoustic output device of claim 1, wherein in a wearing state, a hole portion of the two hole portions that is acoustically coupled with the first front cavity of the first loudspeaker is arranged closer to an ear of a user, a hole portion of the two hole portions that is acoustically coupled with the first rear cavity is arranged further away from the ear of the user, and a direction from the hole portion of the two hole portions that is acoustically coupled with the first rear cavity to the hole portion of the two hole portions that is acoustically coupled with the first front cavity points to the ear of the user.

20. (canceled)

21. The acoustic output device of claim 1, wherein the second front cavity or the second rear cavity that is not acoustically coupled with the hole portion is filled with acoustic granular material.
